(19) United States
(12) Patent Application Publication
(10) Pub. No.: US 2026/0271949 A1
(43) Pub. Date: Sep. 17, 2026

(54) PHOTOSENSITIZER COMPOSITIONS, DEVICES, AND METHODS OF USE FOR SURFACE SANITIZATION OF PROCESSED FOOD PRODUCTS

(71) Applicant: ONDINE INTERNATIONAL AG, Zug (CH)

(72) Inventors: Roger Andersen, Vancouver (CA); Nicolas Allan, Vancouver (CA); Sheeny Levengood, Bothell, WA (US); Nicolas Loebel, Bothell, WA (US); Merle Edwin Olson, Vancouver (CA); Amritha Jaya Prasad, Vancouver (CA); Cristina Romo, Bothell, WA (US); Joseph Ross, Vancouver (CA)

(73) Assignee: ONDINE INTERNATIONAL AG, Zug (CH)

(21) Appl. No.: 19/471,336

(22) PCT Filed: Mar. 28, 2024
(86) PCT No.: PCT/EP2024/058539

§ 371 Date: Sep. 30, 2025

Related U.S. Application Data
(60) Provisional application No. 63/456,325, filed on Mar. 31, 2023.

(51) Int. Cl. A23B 2/775; A23B 2/50; A23B 2/75; A23B 2/767; A23B 2/771; B01J 31/02; B01J 35/39

(52) U.S. Cl. CPC A23B 2/775; A23B 2/50; A23B 2/75; A23B 2/767; A23B 2/771; B01J 31/0271; B01J 35/39; B01J 2231/005; B01J 2531/002

(57) ABSTRACT

Provided herein are food-safe disinfectant compositions for photo-disinfection of meat, food and/or food preparation surfaces, the food-safe disinfectant composition comprising one or more photosensitizer (PS) agents. Also provided are devices or packaging for meat or food that are imbedded with the food-safe disinfectant composition. Further still are provided methods for photo-disinfection of a food surface and for treating or preventing bacterial biofilms on food surfaces.

### CROSS-REFERENCE TO RELATED APPLICATION

This application claims priority to and benefit from U.S. Patent Application Ser. No. 63/456,325, filed on Mar. 31, 2023, which is incorporated by reference herein in its entirety.

### TECHNICAL FIELD

The invention relates generally to the field of food disinfection and sanitization and, more particularly, to the use of natural, food-safe photosensitizer compositions, devices, and methods for surface sanitization of food products and of food processing, preparation, and storage surfaces.

### BACKGROUND

Foodborne illnesses represent a significant problem in respect of population health and increasing healthcare costs worldwide. Millions of people get sick every year from foodborne illnesses caused by foodborne pathogens (e.g., bacteria, fungi, viruses, and protozoa), and many are hospitalized, thereby adding to healthcare costs and further burdening at (or beyond) capacity healthcare systems.

The global food disinfection market size is expected to grow substantially in the upcoming years. Alongside this, the food packaging industry has a value of over USD 1 trillion worldwide, indicating significant potential and further growth of the food disinfection market size in the packaging industry.

While decontamination of meat processing/preparation surfaces, carcasses, and meat can be achieved with existing methods for disinfection, these methods typically rely on harsh and/or potentially toxic chemicals. As examples, current food decontamination involves chlorine compounds, hydrogen peroxide and peroxyacid (PAA), carboxylic acid, UV systems, and ozone oxidation systems. Notably, the chlorine compound segment dominates the global food and beverage disinfection market and is expected to retain its dominance at least in the near future.

In the meat processing industry, Salmonella enterica, Staphylococcus aureus and Methicillin-resistant Staphylococcus aureus (MRSA), along with other pathogens, are prevalent, particularly in the pork industry. Surface contamination of meat may possibly spread to the end user, thereby causing a foodborne illness. Moreover, the surface contamination of meat can lead to decreased shelf-life, for example due to the presence of “food spoilage” microorganisms, such as Pseudomonas fragi and Brochothrix thermosphacta.

There exists a need for improved compositions, devices, and methods for surface sanitization of food products and of food processing, preparation, and storage surfaces.

### SUMMARY

The embodiments of the present disclosure generally relate to novel, natural, food-safe photodynamic anti-biofilm disinfectants for the food processing and meat packing industry, and advantageous methods of use thereof. In particular, the present disclosure relates to food-photosensitizers, combinations thereof and devices and methods for improved surface sanitization of food products and of food processing, preparation and storage surfaces.

In an embodiment, the present disclosure relates to a food-safe disinfectant composition for photo-disinfection of meat, food and/or food preparation surfaces, the composition comprising between about 0.01 and about 1.0% w/v Riboflavin. In an embodiment, the food-safe disinfectant composition comprises about 0.1% w/v Riboflavin. In an embodiment, the Riboflavin is Riboflavin-5′-Phosphate.

In an embodiment, the present disclosure relates to a food-safe disinfectant composition for photo-disinfection of meat, food and/or food preparation surfaces, the composition comprising between about 0.001% and about 0.1% w/v Erythrosin B. In an embodiment, the food-safe disinfectant composition comprises between about 0.01% and about 0.1% w/v Erythrosin B.

In an embodiment, the present disclosure relates to a food-safe disinfectant composition for photo-disinfection of meat, food and/or food preparation surfaces, the composition comprising between about 0.001% and about 1.0% w/v Sunset Yellow FCF. In an embodiment, the food-safe disinfectant composition comprises between about 0.01% and about 0.1% w/v Sunset Yellow FCF.

In an embodiment, the present disclosure relates to a food-safe disinfectant composition for photo-disinfection of meat, food and/or food preparation surfaces, the composition comprising between about 0.01 and about 1.0% w/v Riboflavin and between about 0.00001% and about 0.001% w/v Curcumin. In an embodiment, the food-safe disinfectant composition comprises about 0.1% w/V Riboflavin. In an embodiment, the food-safe disinfectant composition comprises about 0.0001% w/V Curcumin. In an embodiment, the Riboflavin is Riboflavin-5′-Phosphate.

In an embodiment, the present disclosure relates to a device or packaging for meat or food, the device or packaging imbedded with a composition comprising at least one photosensitizer (PS) agent selected from: Riboflavin at a concentration of between about 0.01 and about 1.0% w/V, preferably about 0.1 w/v; Erythrosin B at a concentration of between about 0.001% and about 0.1% w/v, preferably between about 0.01% and about 0.1% w/v; Sunset Yellow FCF at a concentration of between about 0.001% and about 1.0% w/v, preferably between about 0.01% and about 0.1% w/v; or a combination of Riboflavin and Curcumin, wherein the Riboflavin is at a concentration of between about 0.01 and about 1.0% w/v, preferably about 0.1% w/V, and the Curcumin is at a concentration of between about 0.00001% and about 0.001% w/v, preferably about 0.0001% w/v, wherein the device or packaging is configured to allow the PS agent or active species thereof to escape or diffuse therefrom and contact a surface of the meat or food. In an embodiment, the Riboflavin is Riboflavin-5′-Phosphate.

In an embodiment, the device or packaging is a flexible film. In an embodiment, the flexible film is a transparent plastic film.

In an embodiment, the device or packaging is a heat-deformable rigid transparent plastic sheet moldable into a processed food container.

In an embodiment, the active species is singlet oxygen. In an embodiment, the singlet oxygen is capable of diffusing from or off the device or packaging upon irradiation of the PS agent.

In an embodiment, the device, packaging, or PS agent is not in contact with the meat or food to achieve antimicrobial photo-dynamic disinfection (aPDD).

In an embodiment, the present disclosure relates to a method for disinfecting a food surface, the method comprising: a) providing a food having in contact with a surface thereof, or within an effective range, a composition comprising Riboflavin; and b) irradiating the food with a blue light having a wavelength between about 440 nm and about 445 nm to a fluence of at least 50 J/cm². In an embodiment of the method, the Riboflavin is at a concentration of between about 0.01 and about 1.0% w/v, preferably about 0.1 w/v. In an embodiment, the Riboflavin is Riboflavin-5′-Phosphate.

In an embodiment, the present disclosure relates to a method for disinfecting a food surface, the method comprising: a) providing a food having in contact with a surface thereof, or within an effective range, a composition comprising Erythrosin B; and b) irradiating the food with a green light having a wavelength between about 525 nm and about 530 nm, or with broad-spectrum white light, to a fluence of at least 25 J/cm². In an embodiment of the method, the Erythrosin B is at a concentration of between about 0.001% and about 0.1% w/v, preferably between about 0.01% and about 0.1% w/v.

In an embodiment of the method, the irradiating is to a fluence of at least 50 J/cm². In an embodiment, the irradiating is with green light having a wavelength between about 525 nm and about 530 nm. In an embodiment, the irradiating is with broad-spectrum light (e.g. white light).

In an embodiment, the present disclosure relates to a method for disinfecting a food surface, the method comprising: a) providing a food having in contact with a surface thereof, or within an effective range, a composition comprising Sunset Yellow FCF; and b) irradiating the food with a blue light having a wavelength of about 470 nm to a fluence of at least 50 J/cm². In an embodiment of the method, the Sunset Yellow FCF is at a concentration of between about 0.001% and about 1.0% w/V, preferably between about 0.01% and about 0.1% w/V.

In an embodiment, the present disclosure relates to a method for disinfecting a food surface, the method comprising: a) providing a food having in contact with a surface thereof, or within an effective range, a composition comprising Riboflavin and Curcumin; and b) irradiating the food with a blue light having a wavelength of between about 420 nm and about 450 nm to a fluence of at least 50 J/cm². In an embodiment of the method, the Riboflavin is at a concentration of between about 0.01 and about 1.0% w/v, preferably about 0.1% w/v. In an embodiment of the method, the Curcumin is at a concentration of between about 0.00001% and about 0.001% w/v, preferably about 0.0001% w/v. In an embodiment, the Riboflavin is Riboflavin-5′-Phosphate.

In an embodiment of the methods herein, the step of providing the food having in contact with a surface thereof the composition, comprises applying the composition directly to the surface of the food or to a food processing surface onto which the food is placed.

In an embodiment of the methods herein, the step of providing the food having in contact with a surface thereof the composition, comprises applying a packaging around the food wherein the packaging is embedded or coated with the composition.

In an embodiment of the methods herein, the step of providing the food having within an effective range the composition, comprises packaging the food in a manner in which the food is in close proximity with, but not in contact with, a packaging embedded or coated with the composition. In an embodiment, the effective range is between about 1 mm and about 10 mm, preferably between about 1 mm and about 5 mm

In an embodiment of the methods herein, the providing and irradiating steps occur at the same site or facility.

In an embodiment of the methods herein, the providing and irradiating steps occur at different sites or facilities.

In another embodiment, the present disclosure relates to the use of a food-safe photo-dynamic disinfection (PDD) agent for treating or preventing bacterial biofilms on a food surface. In an embodiment of the uses herein, the food has a favourable organoleptic profile without any rinsing of the PDD agent off the food surface. In an embodiment, the favourable organoleptic profile is an absence of any taste imparted by the PDD agent, an absence of any appearance effect on the food surface, an absence of any odor, or any combination thereof.

In an embodiment of the uses herein, the PDD agent is: Riboflavin at a concentration of between about 0.01 and about 1.0% w/v, preferably about 0.1 w/v; Erythrosin B at a concentration of between about 0.001% and about 0.1% w/v, preferably between about 0.01% and about 0.1% w/V; Sunset Yellow FCF at a concentration of between about 0.001% and about 1.0% w/v, preferably between about 0.01% and about 0.1% w/v; or a combination of Riboflavin and Curcumin, wherein the Riboflavin is at a concentration of between about 0.01 and about 1.0% w/v, preferably about 0.1% w/V, and the Curcumin is at a concentration of between about 0.00001% and about 0.001% w/v, preferably about 0.0001% w/v. In an embodiment, the Riboflavin is Riboflavin-5′-Phosphate.

Other aspects and embodiments of the disclosure are evident in view of the detailed description provided herein.

### BRIEF DESCRIPTION OF THE DRAWINGS

These and other features of the present disclosure will become more apparent in the following detailed description in which reference is made to the appended drawings. The appended drawings illustrate one or more embodiments of the present disclosure by way of example only and are not to be construed as limiting the scope of the present disclosure.

FIG. 1 is a flow chart illustrating an experimental process for high-throughput antimicrobial susceptibility testing using a Minimum Biofilm Eradication Concentration (MBEC) assay.

FIG. 2A is a chart showing the challenge plate layout of PS1 (Riboflavin-5′-Phosphate), PS2 (Sunset Yellow FCF) and PS3 (Curcumin) alone. Each plate represents one organism and one irradiation (or dark incubation) time, challenged with PS candidates in quadruplicates.

FIG. 2B is a chart showing the challenge plate layout assay of PS1 (Riboflavin-5′-Phosphate), PS2 (Sunset Yellow FCF) and PS3 (Curcumin) in pair-wise combinations. Each plate represents one organism and one irradiation (or dark incubation) time, challenged with PS candidates in quadruplicates.

FIG. 2C is a chart showing the challenge plate layout for PS4 (Erythrosin B) which was tested, in triplicate, against both organisms with one plate per irradiation time.

FIG. 3 shows the results of the inoculum checks. Panel A is a chart showing quantification results for saturated overnight cultures (“O/N”) and diluted cultures (“DiL”) used as inocula for the MBEC assays; Panel B is a photograph of an agar plate with representative inocula of Salmonella enterica in reference to panel A; and Panel C is a photograph of an agar plate with representative inocula of Methicillin-resistant Staphylococcus aureus (MRSA) in reference to panel A.

FIG. 4 provides representative photographs showing coloration of challenge plates. Panel A is a representative photograph of a 96-well challenge plate with results of individual PS agents P1, P2, and P3. Panel B is a representative photograph of a 96-well challenge plate with results of pair-wise combinations of PS agents P1, P2, and P3.

FIG. 5 shows photographs of challenge plates with green-irradiated PS4 with 2 min, 5 min and min exposure to green irradiation in comparison to a challenge plant incubated in the dark for 10 min.

FIG. 6 is a photograph of a 96-well challenge plate assay with S. enterica after 24 h of incubation followed by 5 min of blue irradiation for individual PS agents P1, P2, and P3.

FIG. 7 shows graphs illustrating the effects of the PS agents on microbial populations in S. enterica biofilms. Panel A with PS1; Panel B with PS2; Panel C with PS3; Panel D with PS1+PS2; Panel E with PS2+PS3; and Panel F with PD1+PS3.

FIG. 8 shows graphs illustrating the effects of the PS agents on microbial populations in MRSA biofilms; Panel A with PS1; Panel B with PS2; Panel C with PS3; Panel D with PS1+PS2; Panel E with PS2+PS3; and Panel F with PD1+PS3.

FIG. 9 shows graphs illustrating the effects of PS4 on S. enterica biofilms (Panel A) and on MRSA biofilms (Panel B).

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, exemplary suitable methods and materials are described below.

The present disclosure relates to novel, natural, food-safe photodynamic anti-biofilm disinfectants for the food processing and meat packing industry, and advantageous methods of use thereof. In particular, the present disclosure relates to food-safe photosensitizers, combinations thereof and devices and methods for improved surface sanitization of food products and of food processing, preparation, and storage surfaces.

Through extensive study, it has been discovered that certain photosensitizer (PS) agents selected from natural, food-safe PS agents, have advantageous properties in the disinfection and sanitization of the surface of foods (e.g., meats) and food processing, preparation, and storage surfaces. This includes, without limitation, advantageous synergistic combinations of natural, food-safe PS agents, as well as advantageous methods for disinfecting a food surface or a food processing, preparation and storage surface, including by way of particular concentrations of PS agents, fluence (e.g., as a measure of irradiation time and power output of light device), light wavelengths, pairwise combinations of PS agents, or any combination thereof.

Also disclosed herein are advantageous uses or applications of food-safe PS agents for the disinfection and sanitization of food surfaces, directly or by way of surfaces that come into contact with foods during processing, preparation and/or storage.

The technology of the present disclosure is aimed at resolving various problems in relation to food safety (e.g., prevention of foodborne illnesses) and food disinfection during processing and preparation, packaging, and storage. For example, certain existing technologies rely on harsh and potentially toxic chemicals (e.g., bleach, ammonia, etc.) or on chemicals that might select for antimicrobial resistance. In contrast, the present disclosure concerns advantageous PS agents that may be used in antimicrobial photo-dynamic disinfection (aPDD) to destroy bacteria, viruses, yeasts and fungi, and associated virulence factors on the surface of foods or on food processing surfaces, without selecting for resistance.

Photo-disinfection involves the administration of a light-sensitive compound, known as a photosensitizer (PS), followed by light irradiation at a specific wavelength that electro-dynamically excites the PS, causing cell destruction through oxidative disruption of the microbial cell membrane. The principle behind the approach, as an example, is illustrated in the following scheme:

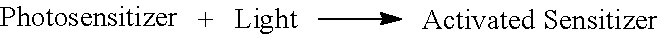

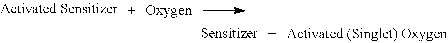

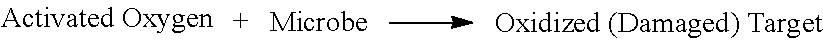

Energy from light is absorbed by the PS and then passed on to molecular oxygen with the formation of the very reactive singlet oxygen. It is the singlet oxygen that causes potentially lethal damage to the target (microbe). During this process, the PS is regenerated so that it acts as a catalyst, and many molecules of singlet oxygen can be formed from a single molecule of PS, so long as light and molecular oxygen are present.

Antimicrobial photo-disinfection therapy (aPDT) is already used in clinical settings and has recently been employed for nasal decolonization in healthcare and workplace settings. For instance, Steriwave™ Nasal Decolonization technology (https://ondinebio.com/solutions/steriwave-healthcare/) has been used to reduce the transmission of SARS-COV-2 amongst workers in the meat-packing industry.

Although aPDT is not new, suitable, effective and advantageous PS agents, combinations thereof, and methods for food disinfection are lacking and advancements in technology are needed at least because: (i) surface contamination of meat may theoretically spread to the end user, (ii) surface decontamination of meat may increase shelf-life, and (iii) certain pathogens, including as examples and without limitation Salmonella enterica, Staphylococcus aureus and Methicillin-resistant Staphylococcus aureus (MRSA), remain prevalent, particularly in the pork industry.

The present disclosure relates to technologies and advancements to eliminate foodborne pathogens and food spoilage microorganisms from processed food surfaces, carcasses, and meat processing surfaces. Without limitation, potential applications of the technology herein include: food processing plants, packing plants for disinfection of food (e.g. meat) and hard surfaces, retail applications (e.g. in-store light application or foods administered with PS agents herein or packaged in materials having embedded therein PS agents herein), and consumer applications (e.g. in the home).

Without limitation, advantages of the technology of the present disclosure may include: (i) non-antibiotic treatment (avoids all risks associated with resistance); (ii) no organoleptic issues (no effect on food/taste); (iii) addition of fortifying effects of the vitamin; (iv) all natural/organic product; (v) controllability in respect of antimicrobial disinfection (e.g. only during irradiation); (vi) anti-biofilm effectiveness; (vii) absence of rinse limits and/or requirements such that the product can provide long term protection; (ix) extended shelf-life properties of treated foods, (x) broad spectrum effect applicable to multiple pathogens and pathogen types.

A foundation of the present disclosure is to utilize natural and food safe dyes or additives as the PS (either alone or in combination) for this application to provide a product that facilitates access to the natural/organic market. Many natural molecules from plant sources or their derivatives can be utilized as a PS agent in PDT applications. For example, Curcumin is a natural polyphenolic molecule and plant pigment that can be extracted from the powder of the turmeric plant. Additionally, naturally derived porphyrins represent another category of natural PS. Distinctive features of porphyrins are the use of different visible-light wavelengths, the low toxicity of the active molecules for human health, and the possibility of recycling the PS in water-based processing systems. The present disclosure focuses on natural, food safe PS agents, and combinations thereof, having superior properties, including in respect to the PS agent itself (e.g., colour upon irradiation, effective against broad spectrum of pathogens, anti-biofilm activity, etc.) and conditions for disinfection (e.g., concentrations, fluence, wavelengths, etc.), for the food processing industry.

In an embodiment, the present disclosure relates to a food-safe disinfectant composition for photo-disinfection of meat, food and/or food preparation surfaces. The food-safe disinfectant composition comprises at least one photosensitizer (PS) agent and optionally a carrier, excipient, surfactant, or any combination thereof. In an embodiment, the composition includes the carrier, excipient, surfactant, or any combination thereof. In an embodiment, the carrier, excipient or surfactant is any pharmaceutically acceptable carrier, excipient or surfactant. By “pharmaceutically acceptable”, it is meant generally safe for human consumption (e.g., non-toxic) and neither biologically nor otherwise undesirable for human consumption. In an embodiment, the carrier, excipient or surfactant is any cosmetically acceptable carrier, excipient or surfactant. By “cosmetically acceptable”, it is meant generally safe and/or acceptable for use in contact with human skin tissue without undue toxicity, incompatibility, instability, allergic response, and the like. As used herein, by “food-safe” it is likewise meant suitable, safe and/or acceptable for human consumption. In an embodiment, food-safe is intended to mean that the ingredient (e.g. PS agent) is food-grade. In an embodiment, the excipient is a diluent, a binder, a disintegrant, a glidant, a lubricant, a coating, or a colouring agent. In an embodiment, the surfactant is an anionic surfactant, a non-ionic surfactant, a cationic surfactant, or an amphoteric surfactant. In an embodiment, the surfactant is a compound or composition that enables or aids in tissue penetration. In an embodiment, the surfactant is Tween® 80 and/or the like.

The food-safe disinfectant composition of the present disclosure includes at least one photosensitizer (PS) agent. As used herein, “photosensitizer agent”, “PS agent”, “photosensitizer” and “PS” may be used interchangeably and have the same meaning. The PS agent used in the context of the present disclosure is food-safe. In an embodiment, the PS agent is any food-safe ingredient, dye or colouring agent having photosensitizer activity. In an embodiment, the PS agent is an ingredient, additive, dye or colouring agent having photosensitizer activity that has been approved by a government or regulatory agency of any country in the world for use in food. In an embodiment, the PS agent is a Health Canada approved additive or food colouring agent, such as listed at https://www.canada.ca/en/health-canada/services/food-nutrition/food-safety/food-additives/lists-permitted/3-colouring-agents.html, so long as the additive or food colouring agent has photosensitizer activity.

In an embodiment, the PS agent may be any one or more of the following as listed in Table 1:

TABLE 1
Exemplary PS Agents

| Name (per CFIA) | Synonym(s) |
|---|---|
| Alkanet | C.I. Natural Red 20; Shikonin; Alkannin |
| Aluminum Metal | E173 |
| Annatto | Norbixin; C.I. Natural Orange 4 |
| Anthocyanins | Flavylium; Enocyanin; |
| Beet Red | Betanin; Beet Root Red |
| Canthaxanthin | Carophyll Red |
| Carbon Black | E153 |
| Carotene | β-Carotene; C.I. Food Orange 5 |
| Charcoal | |
| Chlorophyll | Chlorophyll A; Natural Green 3 |
| Cochineal | C.I. Natural Red 4; Carmine |
| Iron Oxide | E172 |
| Orchil | C.I. Natural Red 28; Orcein; Archil |
| Paprika | Paprika Oleoresin; Paprika Extract |
| Riboflavin | Vitamin B2 |
| Saffron | Crocin |
| Saunderswood | Pterocarpus santalinus (Red Sandalwood) |
| Silver Metal | E174 |
| Titanium Dioxide | E171 |
| Turmeric | Turmeric Oleoresin (Crude Extract) |
| Curcumin | Natural Yellow 3 (Purified from above) |
| Xanthophyll | Lutein |
| β-apo-8′-carotenal | C.I. Food Orange 6 |
| Ethyl β-apo-8′-carotenoate | C.I. Food Orange 7 |
| Caramel | Caramel Coloring; E150a-d |
| Allura Red | FD&C Red 40 |
| Amaranth | FD&C Red 2 |
| Erythrosine | FD&C Red 3; Erythrosin B |
| Indigotine | FD&C Blue 2 |
| Sunset Yellow FCF | FD&C Yellow 6 |
| Tartrazine | FD&C Yellow 5 |
| Brilliant Blue FCF | FD&C Blue 1 |
| Fast Green FCF | FD&C Green 3 |
| Citrus Red No. 2 | |
| Ponceau SX | FD&C Red 4 |
| Gold | E175; Edible Gold |
| Sodium Copper | Synthetic Copper Complex of Chlorophyll |
| Tomato Lycopene Extract | E160d |
| Calcium Carbonate | Ground Limestone |
| Spirulina extract | |

In an embodiment, the PS agent may be any one or more of Alkanet, Annatto, Anthocyanins, Beet Red, Canthaxanthin, Carotene, Cochineal, Orchil, Paprika, Riboflavin (e.g. Riboflavin-5′-Phosphate), Saffron, Saunderswood, Titanium Dioxide, Turmeric, Curcumin, Xanthophyll, β-apo-8′-carotenal, Ethyl β-apo-8′-carotenoate, Caramel, Allura Red, Amaranth, Erythrosine, Sunset Yellow FCF, Tartrazine, Citrus Red No. 2, Ponceau SX, and Tomato Lycopene Extract.

In an embodiment, the PS agent may be any one or more of the following as listed in Table 2, which further provides an exemplary irradiation wavelength and the colour of the light.

TABLE 2
Exemplary PS Agents with possible Wavelength and Light Source Colour, Light sources, Output and Fluence

| | λₘₐₓ (nm) | | Lumidox II | | |
|---|---|---|---|---|---|
| Photosensitizer | | Confirmed | LED, Part No., | Output | Fluence |
| Candidate | Literature | as Tested^{a} | and λ | (mW/cm²) | (J/cm²) |
| Methylene Blue | 667 | 668 | Deep Red | 160 | 76.8 |
| (Positive Control) | | | LUM296LA660 | | |
| | | | (660 nm) | | |
| Protoporphyrin IX | 542-641 | 643 | Red | 125 | 60.0 |
| Hemin | 400-430 | 642 | LUM296LA630 | | |
| Hemoglobin | 540, 576 | 631 | (630 nm) | | |
| Titanium Dioxide | 400-600 | 1 | Amber | 130 | 62.4 |
| Orchil (Orcein) | 575 | 575 | LUM296LA590 | | |
| Cochineal (Carmine) | 495-560 | 556 | (590 nm) | | |
| Anthocyanin | 550 | 518 | Green | 85 | 40.8 |
| (Cyanidin-3- | | | LUM296LA527 | | |
| glucoside) | | | (527 nm) | | |
| Betanin (Beet Red) | 542 | 537 | | | |
| Black Carrot Extract | 520 | 532 | | | |
| Erythrosin B | 524-527 | 529 | | | |
| Acid Red 27 | 521 | 519 | | | |
| (Amaranth) | | | | | |
| Enocyanin (an | 520 | 520 | | | |
| Anthocyanin) | | | | | |
| Resveratrol (Grape | 520 | 315 | | | |
| Skin Extract) | | | | | |
| Citrus red No. 2 | 510 | 546, 606 | Cyan | 110 | 52.8 |
| Allura Red | 505 | 500 | LUM296LA505 | | |
| Ponceau SX | 501 | 500 | (505 nm) | | |
| Canthaxanthin | 485 | 462 | Blue | 170 | 81.6 |
| Shikonin (Alkanet) | 523 | 483 | LUM296LA470 | | |
| Sunset Yellow FCF | 480 | 481 | (470 nm) | | |
| Tomato Lycopene | 470-516 | 477 | | | |
| Extract | | | | | |
| Paprika | 450-475 | 462 | | | |
| (Capsanthin) | | | | | |
| Trans-β-apo-8′- | 465 | 443 | | | |
| carotenal | | | | | |
| Saffron | 434, 464 | 469 | | | |
| Xanthophyll (Lutein) | 450 | 462 | Indigo | 185 | 88.8 |
| Ethyl β-apo-8′- | 449 | 428-502 | LUM296LA445 | | |
| carotenoate | | | (445 nm) | | |
| Riboflavin | 440-450 | 443 | | | |
| Curcumin | 420 | 428, 500 | Violet | 145 | 69.6 |
| Beta-Carotene | 453-484 | 425 (or 462) | LUM296LA420 | | |
| Tartrazine (Acid | 425 | 425 | (420 nm) | | |
| Yellow 23) | | | | | |
| Norbixin (Annatto) | 461 | 423 | | | |
| Turmeric Extract | 420 | 424 | | | |
| Caramel E150 | 282 | 294 | UV | 120 | 57.6 |
| | | | LUM296LA365 | | |
| | | | (365 nm) | | |

^{a}Wavelength of light as used in initial screen (data not shown).

In an embodiment, the PS agent may be Caramel (E150), Curcumin, Erythrosin B, Riboflavin-5′-Phosphate, Sunset Yellow FCF, or any combination thereof. In an embodiment, the food-safe disinfectant composition of the present disclosure may comprise any one or more of these PS agents. In an embodiment, the food-safe disinfectant composition comprises only one of Curcumin, Erythrosin B, Riboflavin-5′-Phosphate, or Sunset Yellow FCF. In an embodiment, the food-safe disinfectant composition comprises a combination of Curcumin and Erythrosin B; Curcumin and Riboflavin-5′-Phosphate; Curcumin and Sunset Yellow FCF; Erythrosin B and Riboflavin-5′-Phosphate; Erythrosin B and Sunset Yellow FCF; or Riboflavin-5′-Phosphate and Sunset Yellow FCF. In an embodiment, the food-safe disinfectant composition comprises a combination of Riboflavin-5′-Phosphate and Sunset Yellow FCF. In an embodiment, the food-safe disinfectant composition comprises a combination Sunset Yellow FCF and Curcumin. In an embodiment, the food-safe disinfectant composition comprises a combination of Riboflavin-5′-Phosphate and Curcumin.

In an embodiment, the present disclosure provides synergistic combinations of PS agents for use in the food-safe disinfectant compositions herein. As used herein, “synergistic combination” is intended to refer to a combination of PS agents that provides more than an additive advantage of the individual PS agents. The synergistic effect may be in respect of any of a number of properties including reduced concentration of one or both of the PS agents, more effective antimicrobial activity (e.g., disinfection capability), reduced fluence requirement of one or both of the PS agents, or any other suitable property. It is noted that the combination of PS agents does not also provide an additive advantage, such as demonstrated herein. Thus, even a slight synergy between PS agents is a significant and surprising advantage.

The PS agents may be used in any suitable concentration in the food-safe disinfectant composition, on the food surface, on the food processing or preparation surface, or embedded within a device or packaging, to provide for disinfection. In an embodiment, the concentration of the PS agent is less than 1.0% w/v. In an embodiment, the concentration of the PS agent is between about 0.000000001% w/v and about 1.0% w/v. In an embodiment, the concentration of the PS agent is between about 0.00001% w/v and about 0.5% w/v. In an embodiment, the concentration of the PS agent is between about 0.0001% w/v and about 0.1% w/v. In an embodiment, the concentration of the PS agent is between about 0.001% w/v and about 0.1% w/v. In an embodiment, the concentration of the PS agent is between about 0.01% w/v and about 0.1% w/v.

In an embodiment, the PS agent is Riboflavin and the concentration is between about 0.0001% w/v and about 1.0% w/v, more preferably between about 0.001% w/v and about 0.1% w/V, and more preferably still between about 0.01% w/v and about 0.1% w/v. In an embodiment, the PS agent is Riboflavin and the concentration is about 0.001% w/v, about 0.075% w/v, about 0.05% w/V, about 0.025% w/v, about 0.01 w/v, about 0.75% w/v, about 0.5% w/v, about 0.25% w/v, or about 0.1%. In an embodiment, the PS agent is Riboflavin and the concentration is about 0.1% w/v. In an embodiment, the Riboflavin is Riboflavin-5′-Phosphate.

In an embodiment, the PS agent is Sunset Yellow FCF and the concentration is between about 0.001% w/v and about 1.0% w/v, more preferably between about 0.001% w/v and about 0.1% w/v, and more preferably still between about 0.01% w/v and about 0.1% w/v. In an embodiment, the PS agent is Sunset Yellow FCF and the concentration is about 0.001% w/v, about 0.075% w/v, about 0.05% w/v, about 0.025% w/v, about 0.01 w/v, about 0.75% w/v, about 0.5% w/v, about 0.25% w/v, or about 0.1%. In an embodiment, the PS agent is Sunset Yellow FCF and the concentration is about 0.01% w/v. In an embodiment, the PS agent is Sunset Yellow FCF and the concentration is about 0.1% w/V.

In an embodiment, the PS agent is Curcumin and the concentration is between about 0.000001% w/v and about 0.01% w/v, more preferably between about 0.00001% w/v and about 0.001% w/V, and more preferably still between about 0.0001% w/v and about 0.001% w/v. In an embodiment, the PS agent is Curcumin and the concentration is about 0.00001% w/v, about 0.00075% w/v, about 0.0005% w/v, about 0.00025% w/v, about 0.0001 w/v, about 0.0075% w/V, about 0.005% w/v, about 0.0025% w/v, or about 0.001%. In an embodiment, the PS agent is Curcumin and the concentration is about 0.00001% w/v. In an embodiment, the PS agent is Curcumin and the concentration is about 0.0001% w/v.

In an embodiment, the PS agent is Erythrosin B and the concentration is between about 0.00001% w/v and about 1.0% w/v, more preferably between about 0.0001% w/v and about 0.1% w/V, more preferably again between about 0.001% w/v and about 0.1% w/v, and more preferably still between about 0.01% w/v and about 0.1% w/v. In an embodiment, the PS agent is Erythrosin B and the concentration is about 0.0001% w/v, about 0.0075% w/v, about 0.005% w/v, about 0.0025% w/V, about 0.001 w/V, about 0.075% w/v, about 0.05% w/v, about 0.025% w/v, about 0.01%, about 0.75% w/v, about 0.5% w/v, about 0.25% w/v, or about 0.1%. In an embodiment, the PS agent is Erythrosin B and the concentration is about 0.01% w/v. In an embodiment, the PS agent is Erythrosin B and the concentration is about 0.1% w/V.

In an embodiment, the PS agent is a combination of Riboflavin and Curcumin; and the concentration of Riboflavin is between about 0.01% w/v and about 0.1% w/v and the concentration of Curcumin is between about 0.00001% w/v and about 0.0001% w/v. In an embodiment, the PS agent is a combination of Riboflavin and Curcumin; and the concentration of Riboflavin is about 0.1% w/V and the concentration of Curcumin is about 0.0001% w/v. In an embodiment, the Riboflavin is Riboflavin-5′-Phosphate.

The PS agents described herein may be included in food-safe disinfectant compositions, devices, and packaging materials, along with various other materials. When included in a liquid composition, it is contemplated herein that the PS agent may be included in the liquid composition at a weight per volume percentage (% w/v) as described herein. When included in a solid product, such as embedded within or coated on a plastic film, Styrofoam, or other packaging material, the amount may still be expressed at a weight per volume (% w/v). However, the skilled person will recognize that for solid or semi-solid mediums, it may be more appropriate to express the amount of PS agent as a weight per weight percentage (% w/w). The skilled person will understand the appropriate calculation to convert the % w/v amounts to % w/w based on the material being used. It is also contemplated herein that it may be advantageous to increase the amount of PS agent as a % w/v or % w/w basis when included in a packaging material since the PS agent may be in contact with the food surface to a lesser extent or amount. For example, the amount should potentially increase based on a calculation that will yield the desired concentration or amount of the PS agent on the surface of the food.

In an embodiment, the present disclosure provides a food-safe disinfectant composition for photo-disinfection of meat, food and/or food preparation surfaces, the composition comprising between about 0.01 and about 1.0% w/v Riboflavin. In an embodiment, the food-safe disinfectant comprises about 0.1 w/v Riboflavin. In an embodiment, the Riboflavin is Riboflavin-5′-Phosphate.

In an embodiment, the present disclosure provides a food-safe disinfectant composition for photo-disinfection of meat, food and/or food preparation surfaces, the composition comprising between about 0.001% and about 0.1% w/v Erythrosin B. In an embodiment, the food-safe disinfectant comprises between about 0.01% and about 0.1% w/v Erythrosin B.

In an embodiment, the present disclosure provides a food-safe disinfectant composition for photo-disinfection of meat, food and/or food preparation surfaces, the composition comprising between about 0.001% and about 1.0% w/v Sunset Yellow FCF. In an embodiment, the food-safe disinfectant comprises between about 0.01% and about 0.1% w/v Sunset Yellow FCF.

In an embodiment, the present disclosure provides a food-safe disinfectant composition for photo-disinfection of meat, food and/or food preparation surfaces, the composition comprising between about 0.01 and about 1.0% w/v Riboflavin and between about 0.00001% and about 0.001% w/v Curcumin. In an embodiment, the food-safe disinfectant comprises about 0.1% w/v Riboflavin and about 0.0001% w/v Curcumin. In an embodiment, the Riboflavin is Riboflavin-5′-Phosphate.

The food-safe disinfectant of the present disclosure may be used to treat or disinfect any surface where contamination (e.g. pathogen, microbial, etc.) may be found. The surface may be any surface capable of being exposed to light.

In an embodiment, the food-safe disinfectant compositions disclosed herein are for application and irradiation at any stage in food processing, retail sale, and consumer handling. For example, the food-safe disinfectant composition may be used in front-end food processing by disinfecting the food product (e.g. meat carcass) before it comes into the processing facility. This would be in contrast to the current state of practice involving scalding, which is generally inefficient.

Also, during food processing, the food-safe disinfectant composition may be used to disinfect a food preparation surface in the food processing facility. The food preparation surface may be any hard or soft surface that comes into contact with the food during processing or preparation. In an embodiment, the food preparation surface is a hard surface (e.g. steel, plastic, glass, wood), including ideally hard, smooth surfaces. The hard surface may be, for example and without limitation, a countertop surface or the surface of a piece of food processing equipment that contacts the food (e.g. knives, saws, grinders, etc.). The surface would be contracted or treated with a food-safe disinfectant composition disclosed herein and then the surface irradiated with the appropriate light source to the desired fluence (J/cm², based on irradiation time and light source power output) to disinfect the surface.

In another embodiment, the food-safe disinfectant composition disclosed herein is for application to the surface of a food product. An appropriate time for such treatment may for example be just prior to packaging. The food surface would be contracted or treated with a food-safe disinfectant composition disclosed herein and then the surface may be immediately irradiated prior to packaging or, if the packaging permits the passage of light, the treated food may be packaged and then irradiated afterwards, such as at the packaging facility, at the site or retail sale, in the hands of the consumer, or any combination thereof. Thus, the food-safe disinfectant composition may be applied and irradiated at the same stage or may be applied at a first stage (e.g. during food processing) and irradiated at a later stage (e.g. during retail sale). Thus, advantageously, the food-safe disinfectant composition of the present disclosure is capable of providing food disinfection prior to packaging and post-packaging. Not only is this advantageous from the perspective of preventing foodborne illness, but also for improving the shelf-life of foods.

Having regard to the foregoing, in an embodiment the food-safe disinfectant composition herein is for application to a food preparation surface. In another embodiment, the food-safe disinfectant composition herein is for application to the surface of a food product.

The food or food product may be any suitable food, and preferably is a meat or a meat-based product. The meat may be any type of meat including red meat, poultry meat, or seafood. The red meat may for example be any livestock or game meat, including without limitation beef, pork, goat, lamb, elk, bison, deer, etc. The poultry meat may be any bird or rabbit meat, including without limitation chicken, turkey, duck, etc. The seafood may be any fish or other seafood, including without limitation salmon, trout, scallops, etc. In other embodiments, the food or food product may be a fruit or vegetable. In other embodiments, the food or food product may be a cheese or milk product.

As used herein, by “surface of a food product” or “food surface”, it is intended to mean the exterior surface of a food. The food surface may be the exterior surface of a carcass (e.g. animal carcass) or may be a surface exposed during food processing, e.g. exposed by cutting or grinding of meat.

In other embodiments, the food-safe disinfectant composition may be used on human tissues, such as for example skin (e.g. hands). Treatment of hands may assist in preventing cross-contamination of food or food-preparation surfaces.

In an embodiment, the PS agents within the food-safe disinfectant composition herein are effective in killing microorganisms in the planktonic and biofilm state. In embodiments, such effectiveness is achieved at the concentrations as described herein and/or by the pairwise combinations described herein, including synergistic combinations of PS agents.

The food-safe disinfectant composition, PS agents and PS agent combinations of the present disclosure are capable of disinfecting and sanitizing food and food processing and preparation surface by killing organisms thereon. In an embodiment, the organism is a microorganism such as bacteria, virus, algae, fungus, protozoa, or bacteriophage. In another embodiment, the organism is a parasite, such as a nematode, cestode, trematode, or arthropod. In another embodiment, the organism is an insect. Non-limiting examples of microorganisms include Pseudomonas spp., coliforms (e.g., Escherichia coli), Campylobacter spp., Clostridium perfringens, Cryptosporidium spp. (e.g., C. parvum), Salmonella spp. (e.g., Salmonella enterica), Listeria spp. (e.g., L. monocytogenes), Staphylococcus spp. (e.g., Staphylococcus aureus and Methicillin-resistant Staphylococcus aureus (MRSA)), Aspergillus spp., Fusarium spp., Yersinia spp., Candida spp. (e.g., C. albicans, C. auris). In an embodiment, the microorganism is Salmonella enterica, Staphylococcus aureus or MRSA. In an embodiment, the microorganism is a virus, such as for example and without limitation a Norovirus or a Rotavirus.

In the context of the present disclosure, the PS agents are exposed to light in order to induce killing of organisms and microorganisms. As used herein, “irradiation” or “photoradiation”, used interchangeably, refers to the application of light to the PS agent. Photoradiation may comprise light in the visible spectrum (about 380 nm to about 750 nm), the ultraviolet spectrum (about 100 nm to about 400 nm), or the application of both. In an embodiment, the preferred PS agents of the present disclosure are those which are exposed to visible light to induce killing of organisms and microorganisms. In an embodiment, the visible light is violet (about 380 nm to 420 nm), blue (about 420 nm to about 485 nm), cyan (about 485 nm to about 500 nm), green (about 500 nm to about 565 nm), yellow (about 565 nm to about 590 nm), orange (about 590 nm to about 625 nm), or red (about 625 nm to about 750 nm).

In a particular embodiment, the PS agent used in the context of the present disclosure is one that is efficacious for aPDD by exposure to blue light at a wavelength between about 420 nm to about 485 nm. In an embodiment, the PS agent is Riboflavin-5′-Phosphate and the preferred wavelength as disclosed herein is about 440 nm to about 445 nm. In an embodiment, the PS agent is Curcumin and the preferred wavelength as disclosed herein is about 420 nm to about 450 nm. In an embodiment, the PS agent is Sunset Yellow FCF and the preferred wavelength as disclosed herein is about 470 nm.

In a particular embodiment, the PS agent used in the context of the present disclosure is one that is efficacious for aPDD by exposure to green light at a wavelength between about 500 nm to about 565 nm. In an embodiment, the PS agent is Erythrosin B and the preferred wavelength as disclosed herein is about 525 nm to about 530 nm.

In a particular embodiment, the PS agent used in the context of the present disclosure is one that is efficacious for aPDD by exposure to broad-spectrum light (e.g. white light). As used herein, by “broad-spectrum light” it is meant light containing multiple different wavelengths or all wavelengths within the range of about 400 nm to about 700 nm. In an embodiment, the broad-spectrum light is visible, white light. In an embodiment, the PS agent used with the broad-spectrum light is Erythrosin B. In an embodiment, the PS agent used with the broad-spectrum light is Caramel (E150). In an embodiment, the Caramel may be used at a concentration of about 0.1% w/v. In an embodiment, the PS agent used may be a combination of Erythrosin B and Caramel with broad-spectrum (white) irradiation to a fluence of at least 50 mW/cm².

In other embodiments, the present disclosure relates to a device or packaging for meat or food, the device or packaging coated or imbedded with a PS agent as disclosed herein at a concentration as disclosed herein, wherein the device or packaging is configured to allow the PS agent or an active species thereof to escape or diffuse therefrom and contact a surface of the meat or food. As used herein, “coated” is intended to mean that the PS agent is applied to the exterior surface of the device or packaging without substantial infusion of the PS agents into the device or packaging. As used herein, “imbedded” is intended to mean that the PS agent is within the material forming the device or packaging material, and not simply coated on an exterior surface. In the context of the present disclosure, when a PS agent is embedded in a device or packaging material, it remains capable of disinfecting the food surface, e.g., by diffusing out of the material.

As used herein, the term “active species” is intended to refer to a molecule or compound that is formed or its presence is increased upon irradiation of the PS agent. For example, it may an oxidative species. In an embodiment, the active species is singlet oxygen. Oxygen can absorb, or quench, the PS triplet state energy in a non-radiative exchange process. The oxygen molecules then pump their own singlet state forming highly reactive singlet oxygen. In the context of the present disclosure, the singlet oxygen may diffuse off a photosensitized surface comprising the PS agent, thereby disinfecting a food or meat in close proximity without the PS agent or food-safe composition of the present disclosure actually coming in contact with the food or meat. In an embodiment, the singlet oxygen may for example diffuse up to 20 mm or more. In an embodiment, the singlet oxygen may for example diffuse between about 1 mm and about 10 mm. In an embodiment, the singlet oxygen may for example diffuse between about 1 mm and 5 mm.

As used herein, “device” is intended to refer to a material that contacts a food product that may not be considered a packaging material. As an example, the device may be an absorbent pad, tubing through which processed food passes, cooling devices, etc. The device may be made of any suitable material. In an embodiment, the device is comprised in part or in whole of silica, cellulose, plastic, or any combination thereof.

As used herein, “packaging” is intended to refer to any material or structure that may be used to package food, such as meat or seafood. In an embodiment, the packaging is a wrap, a film, a tray, or a container. The packaging may be made of any suitable material. In an embodiment, the packaging is comprised in part or in whole of polyethylene (PE), polypropylene (PP), polyvinyl chloride, (PVC), polyester (PET), polyamide (PA), polyvinylidene chloride (PDVC), ethylene vinyl (EVOH), silica, cellulose, plastic, or any combination thereof. In an embodiment, the packaging is a plastic wrap (e.g., saran). In an embodiment, the packaging is a flexible film. In an embodiment, the wrap or the film are transparent. In an embodiment, the packaging is a heat-deformable rigid plastic sheet moldable into a processed food container.

In another embodiment, the device or the packaging material is comprised in part or in whole of a sustainable material. In an embodiment, the sustainable material is hemp, bamboo, or some other renewable fiber material.

In a particular embodiment, the device or packaging for meat or food is coated or embedded with a food-safe disinfectant composition as disclosed herein. In an embodiment, the food-safe disinfectant composition comprises: (i) Riboflavin at a concentration of between about 0.01 and about 1.0% w/v, preferably about 0.1 w/V; (ii) Erythrosin B at a concentration of between about 0.001% and about 0.1% w/v, preferably between about 0.01% and about 0.1% w/V; (iii) Sunset Yellow FCF at a concentration of between about 0.001% and about 1.0% w/v, preferably between about 0.01% and about 0.1% w/v; or (iv) a combination of Riboflavin and Curcumin, wherein the Riboflavin is at a concentration of between about 0.01 and about 1.0% w/v, preferably about 0.1% w/v, and the Curcumin is at a concentration of between about 0.00001% and about 0.001% w/v, preferably about 0.0001% w/v, wherein the device or packaging is configured to allow the composition to escape therefrom and contact a surface of the meat or food. In an embodiment, the Riboflavin is Riboflavin-5′-Phosphate.

Advantageously, the device or packaging of the present disclosure may be used once, intermittently, or continuously in the disinfection and sanitization of the food or food product therein. For example, immediately upon packaging of the food, the device or packaging may be subjected to photoradiation by light to disinfect the food contained therein. Alternatively, after packaging of the food, the device or packaging may be subjected to photoradiation at a later time to disinfect the food there within, such as at a point of retail sale (e.g., in a refrigerated sales display having suitable lights for photoradiation) or by the consumer. In an embodiment, the device or packaging is only exposed to photoradiation once to disinfect the food. In other embodiments, the device or packaging is exposed to photoradiation multiple times at one or more different locations. In other embodiments, the device or packaging may be exposed to photoradiation continuously (e.g., from time of packaging until consumption).

In another embodiment, the present disclosure relates to a method for disinfecting a food surface, the method comprising: (a) providing a food having in contact with a surface thereof a composition comprising one or more PS agents as described herein; and (b) irradiating the food with one or more lights having suitable wavelength for photodynamic activation of the one or more PS agents.

In an embodiment of the methods here, the providing step comprises applying the composition directly to the surface of the food or to a food processing surface onto which the food is placed. When applied directly on the surface of the food, the composition will coat the surface with the food with the one or more PS agents. When applied to a food processing surface, the PS agents will be transferred to the surface of the food during food processing, thereby likewise placing the one or more PS agents on the surface of the food.

In another embodiment, the providing step comprises applying a packaging around the food wherein the packaging is embedded or coated with the composition. When the packaging is coated with the composition, the PS agents will be transferred to the surface of the food upon packaging, thereby placing the one or more PS agents on the surface of the food. When the packaging is embedded with the composition, the packaging may be configured to allow the PS agents to diffuse out of the packaging and onto the surface of the food.

In an embodiment of the methods herein, the providing and irradiating steps occur at the same site or facility. For example, immediately upon packaging of the food, the device or packaging may be subjected to photoradiation by light to disinfect the food contained therein.

In another embodiment of the methods herein, the providing and irradiating steps occur at different sites or facilities. Alternatively, the providing step may occur at a food processing facility, whereas the irradiation may occur at a later time, such as at a point of retail sale (e.g., in a refrigerated sales display having suitable lights for photoradiation) at the consumer's house.

In an embodiment of the methods herein, the step of irradiating the food with one or more lights may be repeated any number of times. Thus, in an embodiment, the step of irradiation may be performed one, two, three, four, five, or more times. In an embodiment, when the irradiation occurs more than once, it may be at the same location or at two or more different locations. In an embodiment, when the irradiation occurs more than once, it may be with the same or different wavelength of light as any of the other irradiations. In an embodiment, each irradiation with one or more lights is with the same wavelength(s) of light. In an embodiment, each irradiation is with a different wavelength of light, for example to induce photodynamic activation of a different PS agent each time. Thus, in the methods herein, disinfection of the food can occur two or more different times, each time with a different PS agent.

The duration and power of the irradiation may be different for each PS agent. The irradiation time to achieve a particular fluence (i.e., Joules per unit area; a measure of the total radiant energy delivered to a surface) will depend upon the power output of the light source (i.e., the irradiance), in mW per unit area, and the time period of irradiation (in seconds). As disclosed herein, PS agents may have a preferred fluence in the food-safe disinfectant, devices, packaging and methods of the present disclosure for the most effective and advantageous antimicrobial activity.

In an embodiment of the methods herein, the fluence or energy density to be delivered during the one or more steps of irradiation is between about 5.0 J/cm² and about 100.0 J/cm², more particularly between about 10.2 J/cm² and about 51.0 J/cm², and more preferably still between about 25.5 J/cm² and about 51.0 J/cm².

As disclosed herein, particular combinations of PS agent concentration, wavelength of administered light, and fluence of delivered light energy provide the most efficacious and effective disinfection. In addition, particular combinations of PS agents were found to have synergistic effect.

In an embodiment, the present disclosure provides a method for disinfecting a food surface, the method comprising: (a) providing a food having in contact with a surface thereof a composition comprising Riboflavin; and (b) irradiating the food with a blue light having a wavelength between about 440 nm and about 445 nm to a fluence of at least 50 J/cm². In an embodiment, the Riboflavin is at a concentration of between about 0.01 and about 1.0% w/v, preferably about 0.1 w/v. In an embodiment, the Riboflavin is Riboflavin-5′-Phosphate.

In an embodiment, the present disclosure provides a method for disinfecting a food surface, the method comprising: (a) providing a food having in contact with a surface thereof a composition comprising Erythrosin B; and (b) irradiating the food with a green light having a wavelength between about 525 nm and about 530 nm, or with broad-spectrum white light, to a fluence of at least 25 J/cm². In an embodiment, the Erythrosin B is at a concentration of between about 0.001% and about 0.1% w/v, preferably between about 0.01% and about 0.1% w/v. In an embodiment, the irradiating is to a fluence of at least 50 J/cm².

In an embodiment, the present disclosure provides a method for disinfecting a food surface, the method comprising: (a) providing a food having in contact with a surface thereof a composition comprising Sunset Yellow FCF; and (b) irradiating the food with a blue light having a wavelength of about 470 nm to a fluence of at least 50 J/cm². In an embodiment, the Sunset Yellow FCF is at a concentration of between about 0.001% and about 1.0% w/v, preferably between about 0.01% and about 0.1% w/V.

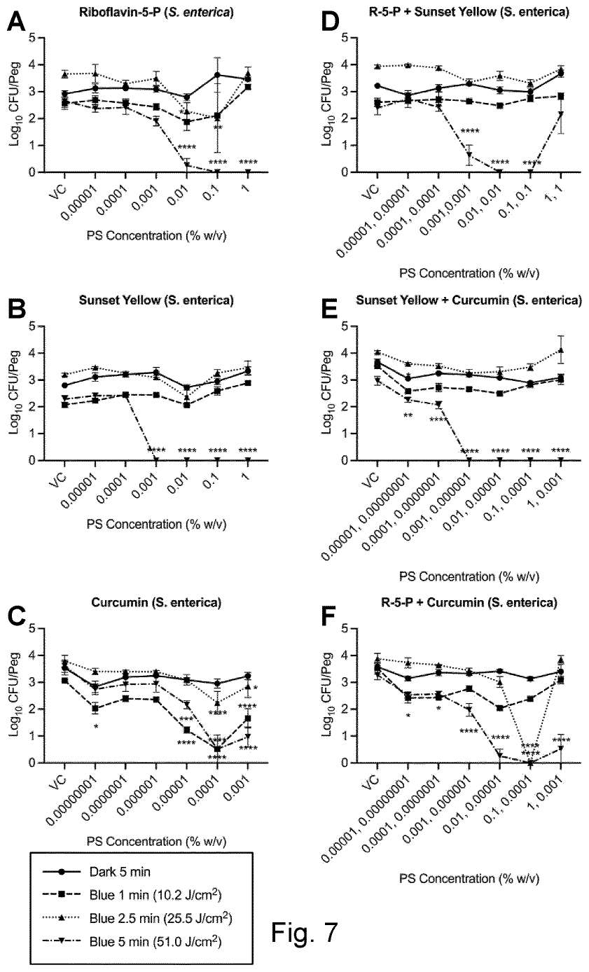

In an embodiment, the present disclosure provides a method for disinfecting a food surface, the method comprising: (a) providing a food having in contact with a surface thereof a composition comprising Riboflavin and Curcumin; and (b) irradiating the food with a blue light having a wavelength of between about 420 nm and about 450 nm to a fluence of at least 50 J/cm². In an embodiment, the Riboflavin is Riboflavin-5′-Phosphate and is at a concentration of between about 0.01 and about 1.0% w/v, preferably about 0.1% w/v and the Curcumin is at a concentration of between about 0.00001% and about 0.001% w/v, preferably about 0.0001% w/v. In an embodiment, the Riboflavin-5′-Phosphate is at a concentration of about 0.1% w/v; the Curcumin is at a concentration of 0.0001% w/v; and the amount of energy delivered is about 25.5 J/cm², which as shown in FIG. 7 (panel F) provides a synergistic effect in killing S. enterica.

In another embodiment, the present disclosure relates to the use of a food-safe photo-dynamic disinfection (PDD) agent for treating or preventing bacterial biofilms on a food surface.

Advantageously, it was found herein that the food-safe compositions of the present disclosure, were effective in killing microorganisms in both the planktonic and biofilm state.

Moreover, in an embodiment of the uses herein, the food treated with the food-safe composition of the present disclosure may have a favourable organoleptic profile without any rinsing of the PDD agent off the food surface. This is advantageous in that existing methods using harsh chemicals require significant rinsing to avoid undesirable organoleptic properties. As used herein, by “favourable organoleptic profile”, it is intended to mean the absence of any taste imparted by the PDD agent, the absence of any appearance effect on the food surface, the absence of any odor, or any combination thereof.

In an embodiment, in the uses herein of involving treating or preventing bacterial biofilms on a food surface, the PDD agent is: (i) Riboflavin at a concentration of between about 0.01 and about 1.0% w/v, preferably about 0.1 w/V; (ii) Erythrosin B at a concentration of between about 0.001% and about 0.1% w/v, preferably between about 0.01% and about 0.1% w/V; (ii) Sunset Yellow FCF at a concentration of between about 0.001% and about 1.0% w/v, preferably between about 0.01% and about 0.1% w/v; or (iv) a combination of Riboflavin and Curcumin, wherein the Riboflavin is at a concentration of between about 0.01 and about 1.0% w/v, preferably about 0.1% w/v, and the Curcumin is at a concentration of between about 0.00001% and about 0.001% w/v, preferably about 0.0001% w/v. In an embodiment, the Riboflavin is Riboflavin-5′-Phosphate.

### EXAMPLES

### Example 1

While decontamination of meat processing/preparation surfaces, carcasses, and meat can be achieved with existing methods for disinfection, these methods typically rely on harsh and potentially toxic chemicals.

In this experiment, candidate natural, food-safe photosensitizers (PS) were selected based on an earlier screen (data not shown) and were tested against two pathogens that are prevalent in the meat packing and processing industry, including subsequent sale and storage of meat products. In particular, four PS agents (PS1, PS2, PS3 and PS4) as identified in Table 3 were tested against the two pathogens identified in Table 4, over a selected concentration range, irradiation time, and total fluence as shown in Table 3.

TABLE 3
Photosensitizers and Experimental Design

| | | | Concentration | LED | Total |
|---|---|---|---|---|---|
| | | | Range | Irradiation | Fluence |
| Code | PS^{a} | λ (nm)^{b} | (% w/v)^{c} | Time^{d} | (J/cm²) |
| PS1 | Riboflavin-5′- | 470 | 1 | 5.0 min | 0 |
| | Phosphate | (Blue) | 0.1 | Dark | |
| | Sodium USP | | 0.01 | 1.0 min | 10.2 |
| | | | 0.001 | 2.5 min | 25.5 |
| | | | 0.0001 | 5.0 min | 51.0 |
| | | | 0.00001 | | |
| | | | VC = water | | |
| PS2 | Sunset Yellow | | 1 | | |
| | FCF | | 0.1 | | |
| | | | 0.01 | | |
| | | | 0.001 | | |
| | | | 0.0001 | | |
| | | | 0.00001 | | |
| | | | VC = water | | |
| PS3 | Curcumin | | 0.001 | | |
| | | | 0.0001 | | |
| | | | 0.00001 | | |
| | | | 0.000001 | | |
| | | | 0.0000001 | | |
| | | | 0.00000001 | | |
| | | | VC = 1% | | |
| | | | DMSO | | |
| | | | in water | | |
| PS4 | Erythrosin B | 527 | 1 | 10.0 min | |
| | | (Green) | 0.1 | Dark | |
| | | | 0.01 | 2.0 min | |
| | | | | 5.0 min | |
| | | | 0.001 | 10.0 min | |
| | | | 0.0001 | | |
| | | | 0.00001 | | |
| | | | VC = water | | |

^{a}The top four candidates selected from an initial screen (data not shown).
^{b}The wavelength (λ) was selected based on the peak absorption for the top three candidates. Each of the “Blue” photosensitizers (PS1, PS2, and PS3) were tested, at the indicated λ, alone or in combination with the other two candidates. The “Green” photosensitizer (PS4) was tested alone (i.e., no combination with other PSs) at its λₘₐₓ (i.e., 527 nm).
^{c}Serial dilutions for quantitation of inoculum density were performed in 96-well plates (Nunclon Delta or similar). The diluent was 0.9% saline.
^{d}5 min dark pre-incubation, followed by irradiation for the times specified. Contact temperature of 23 ± 2° C. The pegs of a sterile polystyrene MBEC ™ Device Lid (Innovotech, Inc., Edmonton, AB) were used as the biofilm growth surface.

TABLE 4
Microorganisms

| | | | | Temp | Biosafety |
|---|---|---|---|---|---|
| # | Organism | Source | OSB/OSA | (° C.) | Risk Group |
| 1 | Staphylococcus aureus | 456 S. Yanke | TSB/TSA | 37 | 2 |
| | (MRSA) | | | | |
| 2 | Salmonella enterica | ATCC 10708 | TSB/TSA | 37 | 2 |
| | Serotype | | | | |
| | Choleraesuis | | | | |

OSB = organism specific broth;
OSA = organism specific agar;
TSB = tryptic soy broth;
TSA = tryptic soy agar;
ATCC = American Type Culture Collection.

Testing comprised a semi-quantitative assessment of Minimum Bactericidal Concentration (MBC) and Minimum Biofilm Eradication Concentration (MBEC) by turbidity, as well as a quantitative assessment of anti-biofilm activity by log 10 colony forming unit (CFU) reduction.

It is appropriate to employ a neutralizing agent for determination of minimum bactericidal and fungicidal concentrations. These agents reduce toxicity from the carry-over of biologically active compounds from challenge to recovery media. As examples, it is possible to use β-lactamase to neutralize penicillin, or L-cysteine to neutralize heavy metal cations. In this experiment, a universal neutralizer in a recovery broth was used. The universal neutralizer comprised 1.0 g L-Histidine, 1.0 g L-Cysteine, and 2.0 g reduced glutathione made up to 20 mL in double distilled water. The recovery broth was 1 litre of Mueller Hinton Broth (MHB), supplemented with 20.0 g per litre of saponin and 10.0 g per litre of Tween-80 prior to autoclaving. Adjusted with dilute NaOH to the correct pH (7.0±0.2 at 20° C.), and autoclaved. After autoclaving, to the surfactant supplemented MHB was added 2 mLCaCl₂ (20 mg/L final) and 1 mL MgCl₂ (10 mg/L final) to produce cation adjusted MHB (CAMHB). On the day of testing, added 1 mL of the universal neutralizer was added to every 40 ml of the CAMHB.

### MBEC™ Assay

Generally, this test method specifies the operational parameters required to grow and treat a biofilm in a high throughput screening assay known as the MBEC™ Assay. The assay device consists of a plastic lid with ninety-six (96) pegs and a corresponding receiver plate with ninety-six (96) individual wells that are filled with inoculum. Biofilm is established on the pegs under batch conditions (i.e., no flow of nutrients into or out of an individual well) with gentle mixing. After an appropriate period of growth, the lid—with the biofilm established on the pegs—is rinsed to remove planktonic cells before placing in a new receiver plate (the “challenge plate”) for antimicrobial efficacy testing. After a specified contact time and irradiation time, the pegged lid is rinsed again, placed in a receiver plate containing the recovery broth, and the entire device is placed in a sonicator to remove the biofilm and disaggregate the clumps. While this recovery plate sonicates, 20 μL of the medium from the challenge plate is removed from each well and placed into 180 μL of fresh medium; after incubating this outgrowth plate, turbidity is used to assess the MBC. The sonicated recovery plate is incubated, and turbidity is used to assess the MBEC. Samples from each well of the recovery plate are also diluted, plated, and the viable cells enumerated. The logo reduction in viable cells is calculated by subtracting the mean logo density for the treated biofilm from the mean log 10 density determined for the untreated controls. The carrier design allows for the simultaneous testing of multiple antimicrobials with replicate samples, making it an efficient screening tool.

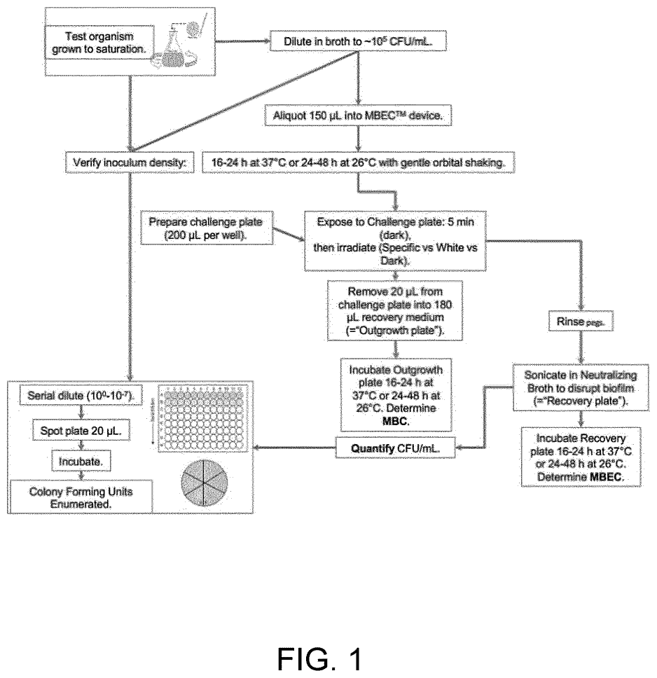

A flow diagram representing the experimental process for high-throughput antimicrobial susceptibility testing using the MBEC™ Assay is shown in FIG. 1. This protocol may be broken into a series of steps, each of which is detailed below.

### Culture/Inoculum Preparation

Using a cryogenic stock (at −70° C.), a first sub-culture of the organisms listed in Table 4 was streaked on organism specific agar (OSA). The plates were incubated at 37±1° C. for 16-24 hours and afterwards stored wrapped in parafilm at 4° C. From the first sub-culture, a second sub-culture was streaked out on OSA and incubated as described for the first sub-culture. The second sub-culture was used within 24 hours starting from the time it was first removed from incubation.

Using the second sub-culture, an isolated colony was aseptically removed from the OSA plate and inoculated with 5 mL of organism specific broth (OSB) in a 50 mL screw-top tube. The tube was placed on an orbital shaker in a humidified incubator and incubated at 200 rpm at 37±1° C. for 16-24 hours. This yielded a culture of approximately 10⁹ CFU/mL. One hundred microlitres of the saturated O/N culture was removed and placed separately into each of 3 wells (in row A) of a 96-well plate for an inoculum check.

### Growing the Biofilm

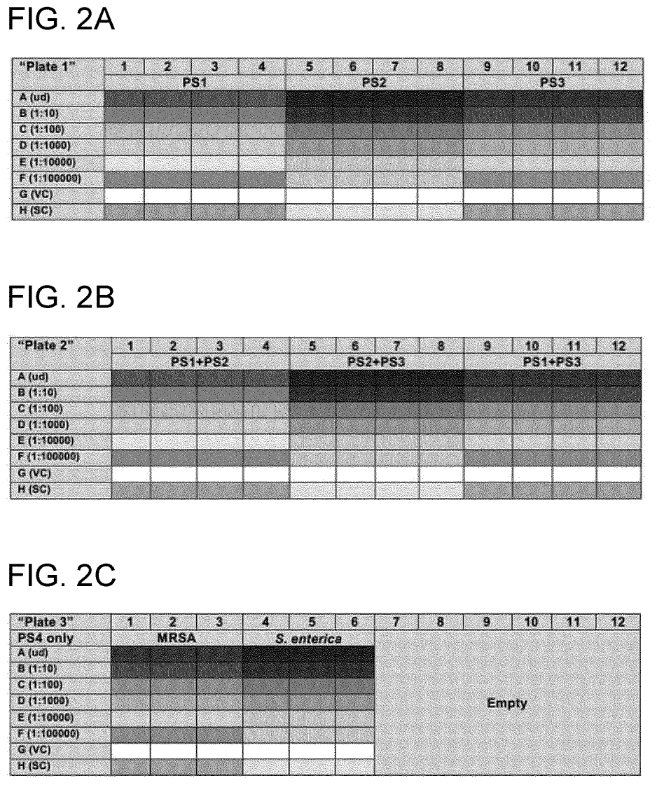

The saturated bacterial cultures were diluted 1:10,000 to an approximate density of 105 CFU/mL. Density was confirmed by an inoculum check. The inoculum was poured into a sterile reagent reservoir. Using a multi-channel pipette, 200 μL of the ~105 inoculum was added to each well from rows A to G of the MBEC™ device, as indicated in FIGS. 2A-2C (12 devices per organism were tested; 4 devices per study day), 200 μL of OSB was added to row H to act as sterility controls (SC). The pegged lid was then placed into the microtiter plate and sealed in a plastic bag. The device was placed on an orbital shaker in a humidified incubator and incubated at 110 rpm at 37±1° C. for 16-24 hours.

### Preparation of Challenge Plates

The challenge plate layouts are as shown in FIGS. 2A-2C. PS agents (PS1: Riboflavin-5′-Phosphate, PS2: Sunset Yellow FCF, PS3: Curcumin) either alone (Plate 1; FIG. 2A) or in pair-wise combination with the other PS agents (Plate 2; FIG. 2B), at an appropriate working stock concentration (denoted as ud), was serially diluted in sterile water (10-fold series) down the rows, as indicated. VC denotes “vehicle” growth controls (i.e., either water, or DMSO diluted 1:100 in water, depending on the PS agent). SC denotes the “sterility controls” (i.e., row H was inoculated with 200 μL OSB and was mock challenged with the highest working stock concentrations of the appropriate PS agents, either alone or in pair-wise combination). Each plate represents one organism and one irradiation (or dark incubation) time, challenged with PS agents in quadruplicates. PS4 (Erythrosin B) was tested, in triplicate, against both test organisms in Plate 3 of FIG. 2C (still one plate per irradiation time).

Preparation of Challenge Plates: A master stock of each PS agent was prepared as follows: (i) 0.6 g of Riboflavin-5′-P was dissolved in 30 mL water to yield 2% w/v. Filter sterilized. Prepared 5 mL aliquots. (ii) 0.8 g of Sunset Yellow FCF was dissolved in 40 mL water to yield 2% w/v. Filter sterilized. Prepared 5 mL aliquots. (iii) 0.005 g of Curcumin was dissolved in 5 mL DMSO to yield 0.1% w/v. Prepared 0.5 mL aliquots. (iv) 0.4 g of Erythrosin B was dissolved in 40 ml water to yield 1% w/v. Filter sterilized.

On each experimental day, an appropriate working stock concentration of each PS agent was prepared as follows: (i) For testing individual PS agents, 2% Riboflavin-5-P or 2% Sunset Yellow FCF were each diluted 2-fold (i.e., 4.5 mL plus 4.5 mL sterile water) to yield 1% w/v working stocks; 0.1% Curcumin was diluted 100-fold (i.e., 100 L plus 9.9 mL sterile water) to yield a 0.001% w/v working stock; and 1% Erythrosin B was not diluted (i.e., 1% w/v was the working stock). (ii) For testing pairwise combinations of PS agents, 0.1% Curcumin was diluted 50-fold (i.e., 200 μL plus 9.8 mL sterile water) to yield a 0.002% w/v working stock; 2% Riboflavin-5-P was mixed in equal parts (i.e., 4.5 mL plus 4.5 mL) with either 2% Sunset Yellow FCF or 0.002% Curcumin, and 2% Sunset Yellow FCF was mixed in equal parts with 0.002% Curcumin.

The working stock was used to prepare the challenge plates; 225 μL of sterile water was added to the wells of rows B-F in Plates 1, 2 and 3. For Plate 1:250 μL of the working stock of each individual PS agent was added to wells A1-4, A4-8 and A9-12, respectively. 225 μL was added to wells H1-4, H4-8, and H9-12 to act as sterility controls (FIG. 2A). For Plate 2:250 μL of the working stock of each individual PS agent was added to wells A1-4, A4-8 and A9-12, respectively. 225 μL was added to wells H1-4, H4-8 and H9-12 to act as sterility controls (FIG. 2B). For Plate 3:250 μL of the working stock of PS4 was added to wells A1-6. 225 μL was added to wells H1-6 to act as sterility controls (FIG. 2B). For all plates, 225 μL of the appropriate vehicle controls (water or DMSO diluted 1:100 in water) was added to the wells in row G (FIGS. 2A-2C).

Using a multi-channel pipettor, serial dilutions from row A to row F were made by transferring 25 μL from row A to row B, then 25 μL from row B to C, then 25 μL from row C to D, then 25 μL from row D to E, and then 25 μL from row E to F. Each time, the contents were mixed by pipetting up and down at least 3 times, the pipette tip was discarded, and a fresh tip was used for the next dilution procedure. Each challenge plate layout (i.e., Plates 1, 2 and 3) was prepared in quadruplicate (one for each treatment time); these plates were prepared fresh on the day of each experiment.

### Antimicrobial Challenge of the Biofilms

Using sterile 96-well receiver plates, rinse plates were prepared (one plate per MBEC lid) by placing 225 L of sterile 0.9% saline in each well. Planktonic cells were rinsed from biofilms that had formed on the lid of the MBEC™ device by dipping the lid into the saline for 120 seconds. The lid was then transferred to the challenge plate and incubated for 5 minutes (protected from light) to allow uptake of the PS agents. After this initial dark incubation, one of the 4 replicate plates was kept in the dark for 5 minutes (Plates 1 and 2) or 10 minutes (Plate 3). The second, third and fourth replicate plates were irradiated with Blue wavelength (Plates 1 and 2) or Green wavelength (Plate 3) for the appropriate time (1, 2.5 and 5 minutes Blue, or 2, 5 and 10 minutes Green).

### Determination of Planktonic MBC (Turbidity Assay)

Using sterile 96-well dilution plates, an appropriate number of outgrowth plates were prepared (1 per MBEC challenge plate) containing 180 μL of OSB per well. After the specified contact time, the MBEC™ lids were removed from the challenge plates and the lids were retained.

20 μL was removed from each well of the challenge plate and placed into the corresponding wells of the outgrowth plate. The outgrowth plates were sealed in plastic bags and incubated at 37±1° C. for 16-24 hours shaking at 110 rpm, protected from light. MBC results were determined following the incubation by +/−growth. Additionally, an Epoch microtiter plate reader (S/N 240268) was used to obtain optical density measurements at 650 nm (OD₆₅₀). Clear wells (OD₆₅₀ less than about 0.05) indicated inhibition following the period of incubation. The MBC (minimum bactericidal concentration) was defined as the minimum concentration that inhibited all visible growth of the organism in this outgrowth plate.

### Determination of MBEC (Turbidity Assay)

Using sterile 96-well receiver plates, rinse plates were prepared (one plate per MBEC lid) containing 225 μL of sterile 0.9% saline per well. The pegs of the MBEC lid were rinsed for 120 seconds.

Using additional sterile 96-well receiver plates, recovery plates were prepared (one per MBEC lid) containing 225 μL per well of the neutralizer/recovery broth, as described above. The MBEC lids were transferred to the recovery broth, and the plates (with the pegged lids) were transferred into a stainless-steel insert tray, which sat in the water of a bath sonicator. Sonication was performed on high for 30 minutes to dislodge surviving biofilm. The pegged lid was then removed and discarded.

One hundred microlitres was removed from each well of row A of the recovery plate into row A of an appropriately labelled 96-well dilution plate; 100 μL was removed from row B of this recovery plate into row A of another 96-well dilution plate. This was repeated for other utilized MBEC rows (total: up to 8 dilution plates per MBEC recovery plate). These plates were kept for the “Quantitative Determination of MBEC (Log₁₀ Reduction Assay)” described below.

125 μL of OSB was added to each well of the recovery plates to top back up to 225 L per well. The contents of the wells were mixed by pipetting up and down. The recovery plates were then sealed in plastic bags and incubated at 37±1° C. for 16-24 hours, shaking at 110 rpm, protected from light. MBEC results were determined following the incubation by +/−growth. Additionally, an Epoch microtiter plate reader (S/N 240268) was used to obtain optical density measurements at 650 nm (OD₆₅₀). Clear wells (OD₆₅₀ less than about 0.05) indicated inhibition following the period of incubation.

The MBEC (minimum biofilm eradication concentration) was defined as the minimum concentration that inhibited all visible growth of the organism in the recovery plate.

### Quantitative Determination of MBEC (Log₁₀ Reduction Assay)

180 μL of sterile 0.9% saline was added to each well of rows B-H of the 96-well dilution plates prepared as described above. The sample in row A was then serially diluted in the saline in rows B-H and spot plated on OSA.

The quantitative MBEC was defined as the minimum concentration of test article that yielded a particular log 10 reduction in biofilm CFUs. For MRSA, >4 log 10 reduction (which corresponds to >99.99% reduction); for S. enterica, >3 log 10 reduction (which corresponds to >99.9% reduction) or, where recovery from the VC controls was <3 log 10, “max kill”.

### Data Collection

MBC values represent the lowest concentration that kills a given microbial population. Results were determined following the incubation of the fresh outgrowth plates, prepared as described above.

MBEC results were determined following the incubation of the MBEC recovery plates, prepared as described above.

Quantitative MBEC results were determined using log 10 reduction. Generally, the appropriate number of colonies were counted on the spot plates according to the plating method used. An appropriate number of colonies that was considered appropriate for counting was a 20 μL spot where the individual colonies were visibly distinct from each other within the plated spot (typically 5-50 colonies). The section in which this spot was located gave the order of magnitude for the cell enumeration: 100-107. The log density for one sample may be calculated as follows:

$${LOG}_{10} ( CFU / peg ) = {LOG}_{10} [ ( X / B ) \times V \times {10}^{D} ]$$

where:
   X=colonies counted on the plated spot,
   B=volume plated (i.e., 0.02 mL),
   V=the volume of recovery broth per well (i.e., 0.2 mL), and
   D=the order of magnitude from the serial dilution.

The log densities for each replicate were averaged.

The log₁₀ reduction was calculated for each test article relative to its corresponding untreated control as follows:

$${Log}_{10} Reduction = ( Mean {Log}_{10} CFU / peg Control ) - ( Mean {Log}_{10} CFU / peg Test )$$

### Results

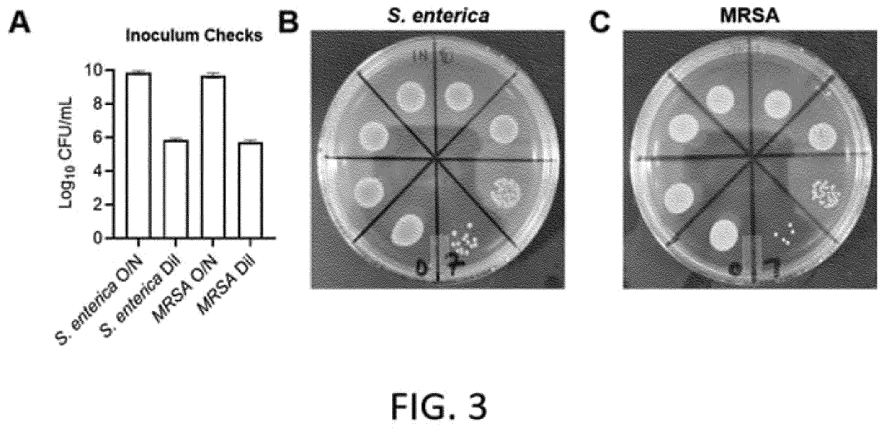

FIG. 3 shows the results of the inoculum checks. In panel A, the saturated overnight cultures (“O/N”) and the diluted cultures (“Dil”) used to inoculate the MBEC devices were quantitated for each individual experiment (i.e., each LED/PS set tested). Each bar represents the mean±standard deviation (SD) for 3 independent experiments. A representative agar quantitation plate is shown for S. enterica (Panel B) and MRSA (Panel C). Inoculum checks were all well within the desired parameters (saturated O/N cultures were upwards of 10⁹ CFU/mL and diluted inocula were around 105-106 CFU/mL).

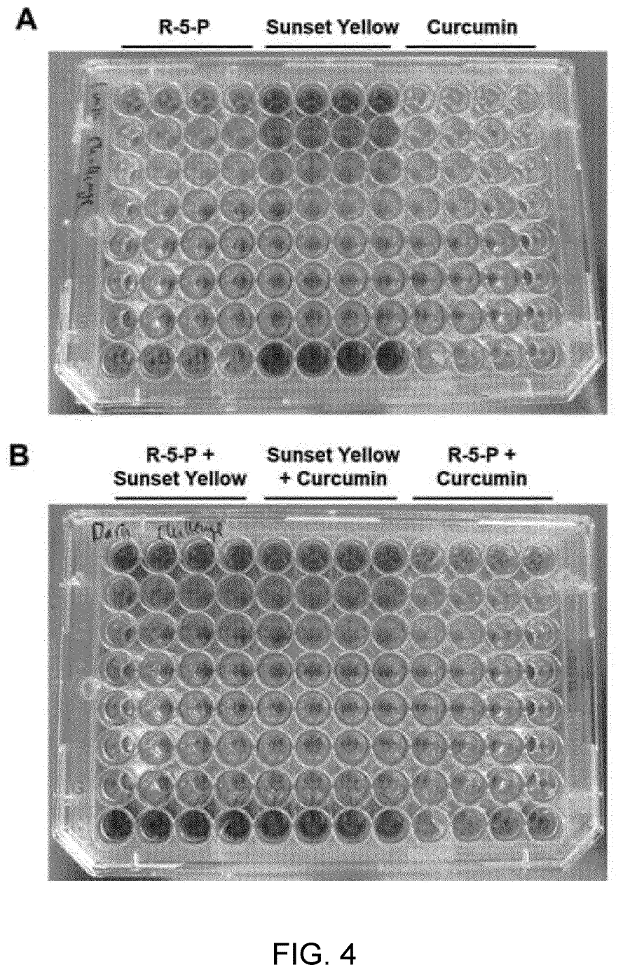

FIG. 4 provides representative photographs showing coloration of challenge plates. Panel A is a representative photograph of a 96-well challenge plate with results of individual PS agents P1, P2, and P3. R-5-P=Riboflavin-5′-Phosphate. Panel B is a representative photograph of a 96-well challenge plate with results of pair-wise combinations of PS agents P1, P2, and P3. The highest tested concentration of Riboflavin-5′-Phophate, Sunset Yellow FCF, and Curcumin (respectively, 1%, 1%, and 0.001% w/v) are orange, red, and pale yellow, respectively, with minimal coloration remaining by the 1:1,000 dilution (0.001, 0.001, and 0.000001% w/v, respectively) (FIG. 4; Panel A). Pairwise combination behave similarly, with Sunset Yellow FCF yielding a similar shade of red regardless of the other PS in the pairing, and Riboflavin-5′-Phosphate yielding a similar shade of orange when paired with Curcumin (FIG. 4; Panel B).

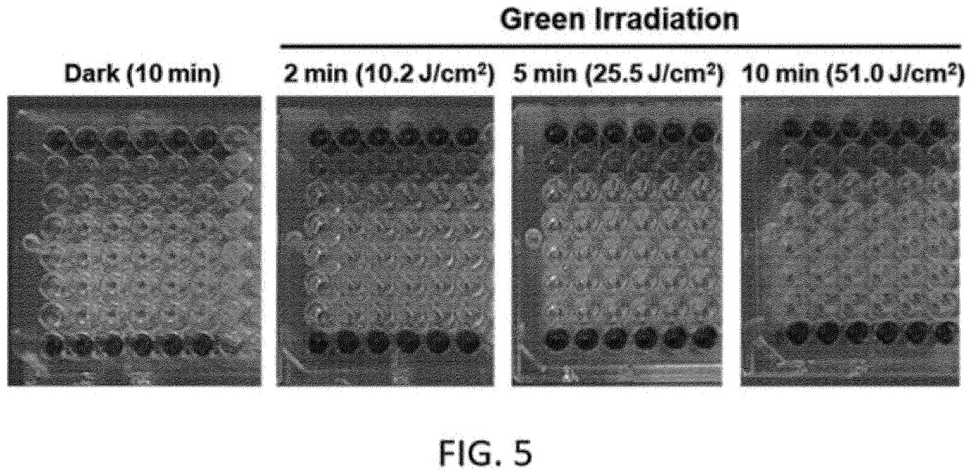

FIG. 5 provides representative photographs showing coloration of challenge plates for the Green-irradiated PS (Erythrosin B) under dark conditions and with green irradiation for 2 min, 5 min and 10 min. The highest tested concentration of Erythrosin B (i.e., 1% w/v) was beet red in color, with the 1:1,000 dilution (i.e., 0.001% w/v) yielding a light pink color and minimal coloration remaining by the 1:10,000 dilution (i.e., 0.0001% w/V) (FIG. 5; left). Interestingly, Erythrosin B lost coloration with increasing irradiation time; this was most evident for the 0.01% and 0.001% concentrations (FIG. 5; left to right).

Table 5, below, provides semi-quantitative (turbidimetric) data for PS1 for a representative recovery plate for S. enterica subjected to 5 minutes of Blue irradiation. Representative visual scoring data after 16-24 hours of incubation is shown whereby values in rows A-H that are bolded and centered in the column indicate wells considered positive for growth.

TABLE 5
Semi-Quantitative (Turbidimetric Data) for PS1 at 5 minutes
Recovery (for MBEC)

| | 1 | 2 | 3 | 4 |
|---|---|---|---|---|
| | PS1 (R-5-P)(% w/v) | | | |
| A | 1 | 1 | 1 | 1 |
| B | 0.1 | 0.1 | 0.1 | 0.1 |
| C | 0.01 | 0.01 | 0.01 | 0.01 |
| D | 0.001 | 0.001 | 0.001 | 0.001 |
| E | 0.0001 | 0.0001 | 0.0001 | 0.0001 |
| F | 0.00001 | 0.00001 | 0.00001 | 0.00001 |
| G | Water | Water | Water | Water |
| H | PS1 sc | PS1 sc | PS1 sc | PS1 sc |

Table 6, below, provides semi-quantitative (turbidimetric) data for PS2 for the same representative recovery plate as Table 5 for S. enterica subjected to 5 minutes of Blue irradiation. Representative visual scoring data after 16-24 hours of incubation is shown whereby values in rows A-H that are bolded and centered in the column indicate wells considered positive for growth.

TABLE 6
Semi-Quantitative (Turbidimetric Data) for PS2 at 5 minutes
Recovery (for MBEC)

| | 5 | 6 | 7 | 8 |
|---|---|---|---|---|
| | PS2 (Sunset Yellow FCF)(% w/v) | | | |
| A | 1 | 1 | 1 | 1 |
| B | 0.1 | 0.1 | 0.1 | 0.1 |
| C | 0.01 | 0.01 | 0.01 | 0.01 |
| D | 0.001 | 0.001 | 0.001 | 0.001 |
| E | 0.0001 | 0.0001 | 0.0001 | 0.0001 |
| F | 0.00001 | 0.00001 | 0.00001 | 0.00001 |
| G | Water | Water | Water | Water |
| H | PS2 sc | PS2 sc | PS2 sc | PS2 sc |

Table 7, below, provides semi-quantitative (turbidimetric) data for PS3 for the same representative recovery plate as Table 5 for S. enterica subjected to 5 minutes of Blue irradiation. Representative visual scoring data after 16-24 hours of incubation is shown whereby values in rows A-H that are bolded and centered in the column indicate wells considered positive for growth.

TABLE 7
Semi-Quantitative (Turbidimetric Data) for PS3 at 5 minutes
Recovery (for MBEC)

| | 9 | 10 | 11 | 12 |
|---|---|---|---|---|
| | PS3 (Curcumin)(% w/v) | | | |
| A | 0.001 | 0.001 | 0.001 | 0.001 |
| B | 0.0001 | 0.0001 | 0.0001 | 0.0001 |
| C | 0.00001 | 0.00001 | 0.00001 | 0.00001 |
| D | 0.000001 | 0.000001 | 0.000001 | 0.000001 |
| E | 0.0000001 | 0.0000001 | 0.0000001 | 0.0000001 |
| F | 0.00000001 | 0.00000001 | 0.00000001 | 0.00000001 |
| G | DMSO:wat | DMSO:wat | DMSO:wat | DMSO:wat |
| H | PS3 sc | PS3 sc | PS3 sc | PS3 sc |

Tables 8-10, below, show the OD₆₅₀ reading for the same plate as represented by Tables 5-7.

TABLE 8
OD₆₅₀ readings for PS1 at 5 minutes

| | 1 | 2 | 3 | 4 |
|---|---|---|---|---|
| A | 0.469 | 0.085 | 0.086 | 0.087 |
| B | 0.087 | 0.09 | 0.093 | 0.091 |
| C | 0.093 | 0.095 | 0.094 | 0.094 |
| D | 0.504 | 0.522 | 0.558 | 0.555 |
| E | 0.52 | 0.516 | 0.575 | 0.546 |
| F | 0.448 | 0.543 | 0.546 | 0.586 |
| G | 0.536 | 0.517 | 0.534 | 0.507 |
| H | 0.086 | 0.089 | 0.089 | 0.089 |

TABLE 9
OD₆₅₀ readings for PS2 at 5 minutes

| | 5 | 6 | 7 | 8 |
|---|---|---|---|---|
| A | 0.087 | 0.088 | 0.088 | 0.088 |
| B | 0.093 | 0.091 | 0.091 | 0.091 |
| C | 0.095 | 0.096 | 0.098 | 0.095 |
| D | 0.097 | 0.096 | 0.1 | 0.098 |
| E | 0.578 | 0.552 | 0.568 | 0.574 |
| F | 0.568 | 0.548 | 0.558 | 0.544 |
| G | 0.496 | 0.52 | 0.575 | 0.544 |
| H | 0.091 | 0.093 | 0.096 | 0.1 |

TABLE 10
OD₆₅₀ readings for PS3 at 5 minutes

| | 9 | 10 | 11 | 12 |
|---|---|---|---|---|
| A | 0.428 | 0.487 | 0.459 | 0.505 |
| B | 0.42 | 0.425 | 0.524 | 0.52 |
| C | 0.528 | 0.541 | 0.528 | 0.497 |
| D | 0.588 | 0.569 | 0.569 | 0.589 |
| E | 0.551 | 0.548 | 0.541 | 0.575 |
| F | 0.519 | 0.57 | 0.577 | 0.567 |
| G | 0.519 | 0.571 | 0.603 | 0.654 |
| H | 0.098 | 0.096 | 0.096 | 0.096 |

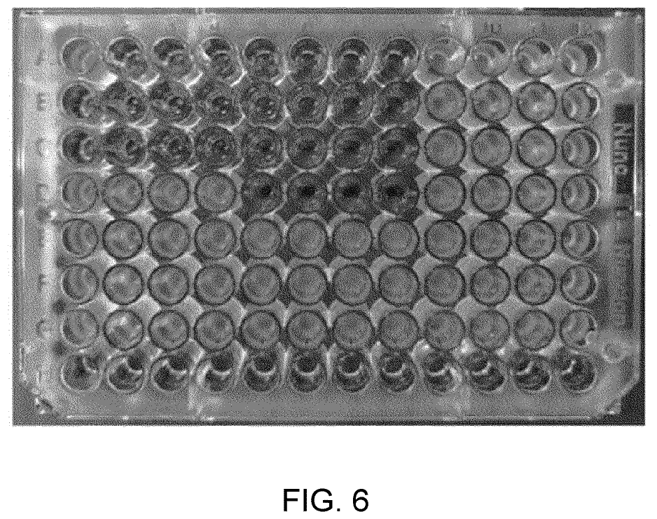

FIG. 6 is a photograph of the same plate as represented by the data in Tables 5-10.

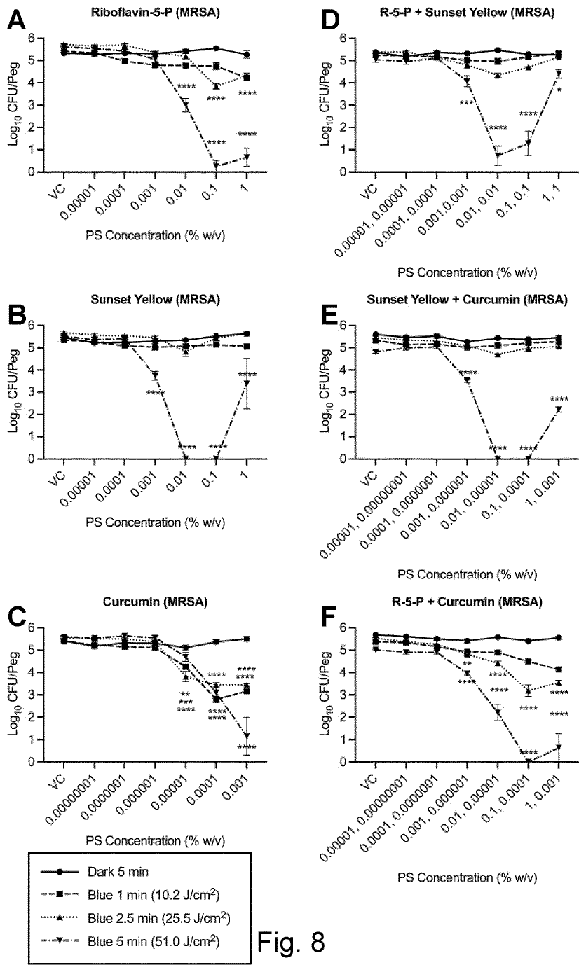

FIGS. 7-8 show graphs depicting the recovery of viable S. enterica (FIG. 7) and viable MRSA (FIG. 8) from Blue-Irradiated MBEC pegs (Log₁₀ CFU/peg). Biofilms were challenged with Riboflavin-5′-Phosphate (Panel A), Sunset Yellow FCF (Panel B), Curcumin (Panel C), Riboflavin-5′-Phosphate+Sunset Yellow FCF (Panel D), Sunset Yellow FCF+Curcumin (Panel E), or Riboflavin-5′-Phosphate+Curcumin (Panel F), at the indicated concentrations (x-axis; VC=Vehicle Controls), for the indicated irradiation times. Symbols and error bars represent the mean±standard deviation (SD) for 4 replicate pegs. Statistical significance, as indicated for certain data points, was evaluated by 2-way ANOVA and P-values (relative to the corresponding “VC” data point for each irradiation condition) were corrected for multiple comparisons using Dunnett's method. *, P<0.05; **, P<0.01; ***, <0.001; ****, P<0.0001.

The quantitative data for S. enterica challenged with the Blue-irradiated set of PS agents is presented in FIG. 7. In general, significant log reductions required the highest irradiation time (i.e., fluence=51.0 J/cm²). When tested individually, Riboflavin-5′-Phosphate, Sunset Yellow FCF, and Curcumin exhibit optimal efficacy at 0.1%, 0.001%, and 0.0001% w/v, respectively (FIG. 7; Panels A-C). Interestingly, Riboflavin-5′-Phosphate and Sunset Yellow FCF typically display dose dependence, wherein higher PS concentrations yield lower S. enterica biofilm viability (FIG. 7; Panels A and B), while Curcumin exhibited a small loss of efficacy at the highest tested concentration (a “hook effect”) (FIG. 7; Panel C). The hook effect was even more pronounced for the pairwise combinations of Riboflavin-5′-Phosphate+Sunset Yellow FCF (FIG. 7; Panel D) and Riboflavin-5′-Phosphate+Curcumin (FIG. 7; Panel F). The pairwise combinations of Riboflavin-5′-Phosphate+Sunset Yellow FCF, Sunset Yellow FCF+Curcumin, and Riboflavin-5′-Phosphate+Curcumin yielded optimal efficacy at 0.01+0.01%, 0.001+0.000001%, and 0.1, 0.0001%, respectively (FIG. 7; Panels D-F).

The quantitative data for MRSA challenged with the Blue-irradiated set of PS agents is presented in FIG. 8. Again, the largest and most significant log reductions generally required the highest irradiation time (i.e., fluence=51.0 J/cm²), although significant log reductions were also achieved with just 25.5 J/cm² for some PS agents (especially Curcumin). Hook effects were exhibited by Riboflavin-5′-Phosphate, but were more pronounced for Sunset Yellow FCF (individually, as well as its pairwise combinations). When tested individually, Riboflavin-5′-Phosphate, Sunset Yellow FCF, and Curcumin exhibit optimal efficacy at 0.1%, 0.01%, and 0.001% w/v, respectively (FIG. 8; Panels A-C). The pairwise combinations of Riboflavin-5′-Phosphate+Sunset Yellow FCF, Sunset Yellow FCF+Curcumin, and Riboflavin-5′-Phosphate+Curcumin yielded optimal efficacy at 0.01+0.01%, 0.01+0.00001%, and 0.1, 0.0001%, respectively (FIG. 8; Panels D-F).

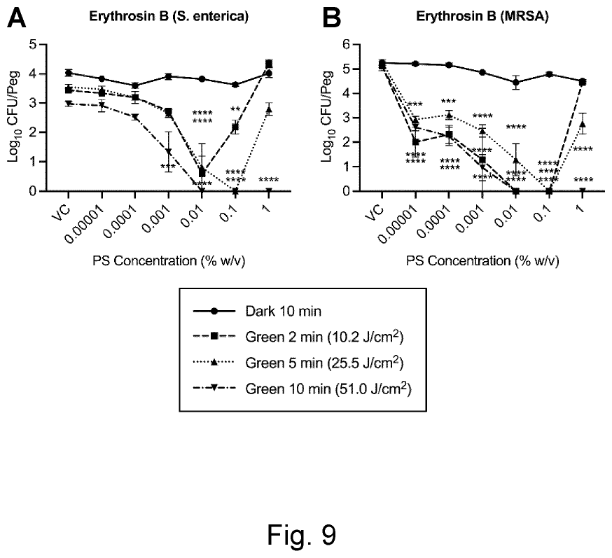

FIG. 9 shows graphs depicting the recovery of viable S. enterica (Panel A) or MRSA (Panel B) from Green-Irradiated MBEC pegs (Log₁₀ CFU/peg). Biofilms were challenged with Erythrosin B, at the indicated concentrations (x-axis; VC=Vehicle Controls), for the indicated irradiation times. Symbols and error bars represent the mean±standard deviation for 3 replicate pegs. Statistical significance, as indicated for certain data points, was evaluated by 2-way ANOVA and P-values (relative to the corresponding “VC” data point for each irradiation condition) were corrected for multiple comparisons using Dunnett's method. *, P<0.05; **, P<0.01; ***, <0.001; ****, P<0.0001.

The quantitative data for S. enterica and MRSA challenged with Erythrosin B and Green Irradiation are presented in FIG. 9. In general, efficacy correlates with light fluence, with optimal efficacy against S. enterica and MRSA being observed at 0.01% and 0.1% at 51.0 J/cm² and 25.5 J/cm², respectively. Interestingly, 0.01% yielded optimal efficacy against MRSA at just 10.2 J/cm².

Table 11, below, provides a summary of the turbidimetric and quantitative data for S. enterica (ATCC 10708).

TABLE 11
Summary of Results-S. enterica

| | | | | Quantitative |
|---|---|---|---|---|
| | | Turbidimetric Assay | | Assay |
| | Fluence | MBC | MBEC | Quant. MBEC |
| PS | (J/cm²) | (% w/V) | (% w/V) | (% w/V) |
| Riboflavin- | 0 (Dark) | >1 | >1 | >1 |
| 5- | 10.2 | >1 | >1 | >1 |
| Phosphate | 25.5 | >1 | >1 | >1 |
| | 51.0 | 0.1 [symbol] | 0.01 [symbol] | 0.1 [symbol] |
| Sunset | 0 (Dark) | >1 | >1 | >1 |
| Yellow | 10.2 | >1 | >1 | >1 |
| FCF | 25.5 | >1 | >1 | >1 |
| | 51.0 | 0.01 [symbol] | 0.001 [symbol] | 0.001 [symbol] |
| Curcumin | 0 (Dark) | >0.001 | >0.001 | >0.001 |
| | 10.2 | >0.001 | >0.001 | >0.001 |
| | 25.5 | >0.001 | >0.001 | >0.001 |
| | 51.0 | >0.001 | >0.001 | 0.0001 [symbol] |
| Riboflavin- | 0 (Dark) | >1, >1 | >1, >1 | >1, >1 |
| 5- | 10.2 | >1, >1 | >1, >1 | >1, >1 |
| Phosphate + | 25.5 | >1, >1 | >1, >1 | >1, >1 |
| Sunset | 51.0 | 0.01, 0.01 [symbol] | 0.01, 0.01 [symbol] | 0.01, 0.01 [symbol] |
| Yellow FCF | | | | |
| Sunset | 0 (Dark) | >1, >0.001 | >1, >0.001 | >1, >0.001 |
| Yellow | 10.2 | >1, >0.001 | >1, >0.001 | >1, >0.001 |
| FCF + | 25.5 | >1, >0.001 | >1, >0.001 | >1, >0.001 |
| Curcumin | 51.0 | 0.001, | 0.001, | 0.001, |
| | | 0.000001 [symbol] | 0.000001 [symbol] | 0.000001 [symbol] |
| Riboflavin- | 0 (Dark) | >1, >0.001 | >1, >0.001 | >1, >0.001 |
| 5- | 10.2 | >1, >0.001 | >1, >0.001 | >1, >0.001 |
| Phosphate + | 25.5 | 0.1, 0.0001 (Ø) | 0.1, 0.0001 (Ø) | 0.1, 0.0001 [symbol] |
| Curcumin | 51.0 | 0.1, 0.0001 [symbol] | 0.1, 0.0001 [symbol] | 0.01, |
| | | | | 0.00001 [symbol] |
| Erythrosin | 0 (Dark) | >1 | >1 | >1 |
| B | 10.2 | 0.01 (Ø) | 0.01 (Ø) | >1 |
| | 25.5 | 0.01 [symbol] | 0.01 (Ø) | 0.1 [symbol] |
| | 51.0 | 0.01 [symbol] | 0.01 [symbol] | 0.01 [symbol] |

For S. enterica, Quant. MBEC = lowest concentration yielding either >3 log₁₀ reduction or max kill (whichever is greater). For turbidimetric data, cells containing “(Ø)” indicates that 3 of 4 wells were clear (“Blue” set) or 2 of 3 wells were clear (Erythrosin B). Cells containing [symbol] indicates that all wells were clear.

As shown in the above results, Sunset Yellow FCF lost potency in combination with Riboflavin-5-Phosphate, whereas when combined with Curcumin it had about the same potency (i.e., not hindered). Also, the results indicate that the combination of Riboflavin-5-Phosphate and Curcumin exhibited improved efficacy at 2.5 min, with a synergistic effect being observed. Also, with this combination, there was improved efficacy at 0.01% Riboflavin-5-Phosphate and 0.00001% Curcumin, with a synergistic effect being observed. Lastly, it was observed that Erythrosin was potent even at just 25.5 J/cm².

For S. enterica (Table 11), the quantitative MBEC for Riboflavin-5′-Phosphate, Sunset Yellow FCF, and Curcumin (individually) was 0.1%, 0.001%, and 0.0001% w/v, respectively. Riboflavin-5′-Phosphate+Sunset Yellow FCF yielded an MBEC of 0.01%+0.01%, indicating a loss of potency for Sunset Yellow FCF when paired with Riboflavin-5′-Phosphate (relative to Sunset Yellow FCF alone). Sunset Yellow FCF+Curcumin yielded an MBEC of 0.001%+0.000001%, indicating that Sunset Yellow FCF maintained a similar potency when paired with Curcumin (i.e., no antagonism or synergy). Interestingly, Riboflavin-5′-Phosphate+Curcumin had an MBEC of 0.01+0.00001% at the same fluence (i.e., 51.0 J/cm²) as the individual agents, and 0.1 and 0.0001% even at the lower fluence of 25.5 J/cm², indicating synergy between these two PS agents. Finally, Erythrosin B (individually) was potent, with an MBEC of 0.1 and 0.01% at 25.5 and 51.0 J/cm², respectively.

Table 12, below, provides a summary of the turbidimetric and quantitative data for MRSA (456 Yanke).

TABLE 12
Summary of Results-MRSA

| | | Turbidimetric Assay | | Quantitative |
|---|---|---|---|---|
| | Fluence | MBC | MBEC | Assay Quant. |
| PS | (J/cm²) | (% w/V) | (% w/V) | MBEC (% w/V) |
| Riboflavin- | 0 (Dark) | >1 | >1 | >1 |
| 5- | 10.2 | >1 | >1 | >1 |
| Phosphate | 25.5 | 0.1 (Ø) | >1 | >1 |
| | 51.0 | 0.1 [symbol] | 0.1 (Ø) | 0.1 [symbol] |
| Sunset | 0 (Dark) | >1 | >1 | >1 |
| Yellow | 10.2 | >1 | >1 | >1 |
| FCF | 25.5 | >1 | >1 | >1 |
| | 51.0 | 0.01 [symbol] | 0.01 [symbol] | 0.01 [symbol] |
| Curcumin | 0 (Dark) | >0.001 | >0.001 | >0.001 |
| | 10.2 | >0.001 | >0.001 | >0.001 |
| | 25.5 | >0.001 | >0.001 | >0.001 |
| | 51.0 | 0.001 [symbol] | >0.001 | 0.001 [symbol] |
| Riboflavin- | 0 (Dark) | >1, >1 | >1, >1 | >1,>1 |
| 5- | 10.2 | >1, >1 | >1, >1 | >1, >1 |
| Phosphate + | 25.5 | >1, >1 | >1, >1 | >1, >1 |
| Sunset | 51.0 | 0.01, 0.01 (Ø) | 0.01, 0.01 (Ø) | 0.01, 0.01 [symbol] |
| Yellow | | | | |
| FCF | | | | |
| Sunset | 0 (Dark) | >1, >0.001 | >1, >0.001 | >1, >0.001 |
| Yellow | 10.2 | >1, >0.001 | >1, >0.001 | >1, >0.001 |
| FCF + | 25.5 | >1, >0.001 | >1, >0.001 | >1, >0.001 |
| Curcumin | 51.0 | 0.01, | 0.01, | 0.01, |
| | | 0.00001 [symbol] | 0.00001 [symbol] | 0.00001 [symbol] |
| Riboflavin- | 0 (Dark) | >1, >0.001 | >1, >0.001 | >1, >0.001 |
| 5- | 10.2 | 0.1, 0.0001 [symbol] | >1, >0.001 | >1, >0.001 |
| Phosphate + | 25.5 | 0.1, 0.0001 [symbol] | >1, >0.001 | >1, >0.001 |
| Curcumin | 51.0 | 0.1, | 0.1, | 0.1, |
| | | 0.0001 [symbol] | 0.0001 [symbol] | 0.0001 [symbol] |
| Erythrosin | 0 (Dark) | 1 [symbol] | >1 | >1 |
| B | 10.2 | 0.001 [symbol] | 0.1 [symbol] | 0.01 [symbol] |
| | 25.5 | 0.0001 [symbol] | 0.1 [symbol] | 0.01 [symbol] |
| | 51.0 | 0.0001 [symbol] | 0.01 [symbol] | 0.001 [symbol] |

For MRSA, Quant. MBEC = lowest concentration yielding >4 log₁₀ reduction. For turbidimetric data, cells containing “(Ø)” indicates that 3 of 4 wells were clear (“Blue” set). Cells containing “ [symbol] ” indicates that all wells were clear.

As shown in the above results, Sunset Yellow FCF had the same potency when combined with either Riboflavin-5-Phosphate or Curcumin as when Sunset Yellow FCF was used individually, thus neither Riboflavin-5-Phosphate nor Curcumin hindered. Likewise, Riboflavin-5-Phosphate had the same potency when combined with Curcumin as when used individually, thus Curcumin did not hinder. Lastly, it was observed that Erythrosin was potent even at just 10.2 J/cm².

For MRSA (Table 12), the quantitative MBEC for Riboflavin-5′-Phosphate, Sunset Yellow FCF, and Curcumin (individually) was 0.1%, 0.01%, and 0.001% w/v, respectively. Riboflavin-5′-Phosphate+Sunset Yellow FCF yielded an MBEC of 0.01%, indicating that Sunset Yellow FCF maintained a similar potency when paired with Riboflavin-5′-Phosphate (i.e., no antagonism or synergy). Sunset Yellow FCF+Curcumin yielded an MBEC of 0.01%+0.00001%, indicating that Sunset Yellow FCF maintained a similar potency when paired with Curcumin (i.e., no antagonism or synergy). Riboflavin-5′-Phosphate+Curcumin had an MBEC of 0.1+0.0001%, indicating that Riboflavin-5′-Phosphate maintained a similar potency when paired with Curcumin (i.e., no antagonism or synergy). Finally, Erythrosin B (individually) was potent, with an MBEC of 0.01% at 10.2 J/cm².

Taken together, the results herein demonstrate, among other things, that a pairwise combination of 0.1% Riboflavin-5′-Phosphate (R-5′-P)+0.0001% Curcumin irradiated with 51.0 J/cm² of Blue light (470 nm) is very effective and efficacious for antimicrobial photodynamic disinfection (aPDD) treatment. Notably, based on results of an earlier screen (data not shown), Indigo light at 445 nm may be even more effective and efficacious for these PS agents. However, the results herein further support individual PS agents as also being very effective for surface sanitization of processed food products.

Erythrosin B may also be advantageous in that it starts off pink and loses color (becoming almost transparent) upon irradiation. For sanitization of food products, this is a relevant and advantageous property. R-5′-P (i.e., vitamin B2) may also be advantageous as it is a nutritive supplement and not a synthetic dye.

At 0.1%, R-5′-P achieved max kill and 5.36 log 10 reduction for S. enterica and MRSA, respectively, after 5 minutes of blue irradiation (=51.0 J/cm²). After 5 minutes of green irradiation (=25.5 J/cm²), Erythrosin B achieved a similar log 10 reduction (max kill and 5.28 log 10 reduction for S. enterica and MRSA, respectively) at 0.1%. Increasing the green irradiation time to 10 minutes (=51.0 0 J/cm²) was found to allow max kill for both organisms at 0.01% Erythrosin B. At 0.01%, Erythrosin B is a shade of pink similar in intensity to the shade of orange displayed by 0.1% R-5′-P, so staining of meat or surfaces (if any) should be similar.

In the present disclosure, all terms referred to in singular form are meant to encompass plural forms of the same. Likewise, all terms referred to in plural form are meant to encompass singular forms of the same. Unless defined otherwise, all technical and scientific terms used herein have the same meaning as commonly understood by one of ordinary skill in the art to which this disclosure pertains.

As used herein, the term “about” refers to an approximately +/−10% variation from a given value. It is to be understood that such a variation is always included in any given value provided herein, whether or not it is specifically referred to.

As used herein, the term “substantially” refers to an approximately +/−5% variation from a given value. If a value is not used, then substantially means almost completely, but perhaps with some variation, contamination and/or additional component. In some embodiments, “substantially” may include completely.

It should be understood that the products and methods are described in terms of “comprising,” “containing,” or “including” various components or steps, the products and methods can also “consist essentially of” or “consist of the various components and steps”. Moreover, the indefinite articles “a” or “an”, as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b” or, “from a to b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are discussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents that may be referenced herein, the definitions that are consistent with this specification should be adopted.

Many obvious variations of the embodiments set out herein will suggest themselves to those skilled in the art in light of the present disclosure. Such obvious variations are within the full intended scope of the appended claims.

1.-42. (canceled)

43. A method for disinfecting a food surface, the method comprising:
a) providing a food having in contact with a surface thereof, or within an effective range, a composition comprising Riboflavin; and
b) irradiating the food with a violet-cyan light having a wavelength between about 380 nm and about 500 nm, with broad-spectrum white light having a wavelength between about 400 nm and about 700 nm, or with a combination thereof, to a fluence of at least 5 J/cm2.

44. The method of claim 43, wherein the Riboflavin is at a concentration of between about 0.00001% and about 1.0% w/v.

45. The method of claim 43, wherein the Riboflavin is Riboflavin-5′-Phosphate.

46. A method for disinfecting a food surface, the method comprising:
a) providing a food having in contact with a surface thereof, or within an effective range, a composition comprising Erythrosin B; and
b) irradiating the food with a blue-green light having a wavelength between about 420 nm and about 565 nm, with broad-spectrum white light having a wavelength between about 400 nm and about 700 nm, or with a combination thereof, to a fluence of at least 5 J/cm2.

47. The method of claim 46, wherein the Erythrosin B is at a concentration of between about 0.00001% and about 1.0% w/v.

48. The method of claim 46, wherein the irradiating is to a fluence of at least 50 J/cm2.

49. A method for disinfecting a food surface, the method comprising:
a) providing a food having in contact with a surface thereof, or within an effective range, a composition comprising Sunset Yellow FCF; and
b) irradiating the food with a violet-green light having a wavelength between about 380 nm and about 565 nm, to a fluence of at least 5 J/cm2.

50. The method of claim 49, wherein the Sunset Yellow FCF is at a concentration of between about 0.00001% and about 1.0% w/v.

51. The method of claim 43, wherein the composition comprises Riboflavin and Curcumin.

52. The method of claim 51, wherein the Riboflavin is at a concentration of between about 0.00001% and about 1.0% w/v.

53. The method of claim 51, wherein the Curcumin is at a concentration of between about 0.00001% and about 1.0% w/v.

54. The method of claim 51, wherein the Riboflavin is Riboflavin-5′-Phosphate.

55. The method of claim 51, wherein the step of providing the food having in contact with a surface thereof the composition, comprises applying the composition directly to the surface of the food or to a food processing surface onto which the food is placed.

56. The method of claim 51, wherein the step of providing the food having in contact with a surface thereof the composition, comprises applying a packaging around the food wherein the packaging is embedded or coated with the composition.

57. The method of claim 51, wherein the step of providing the food having within an effective range the composition, comprises packaging the food in a manner in which the food is in close proximity with, but not in contact with, a packaging embedded or coated with the composition.

58. The method of claim 57, wherein the effective range is between about 1 nm and about 1 cm.

59. The method of claim 51, wherein the providing and irradiating steps occur at the same site or facility.

60. The method of claim 51, wherein the providing and irradiating steps occur at different sites or facilities.
